(19) United States
(12) Patent Application Publication
(10) Pub. No.: US 2026/0288715 A1
(43) Pub. Date: Sep. 24, 2026

(54) SYSTEM

(71) Applicant: SoftBank Group Corp., Tokyo (JP)

(72) Inventor: Takeshi OGAWA, Tokyo (JP)

(73) Assignee: SoftBank Group Corp., Tokyo (JP)

(21) Appl. No.: 19/568,801

(22) Filed: Mar. 17, 2026

(30) Foreign Application Priority Data
Mar. 19, 2025 (JP) 2025-045122

(51) Int. Cl. G06F 16/2452; G06F 16/2457; G06F 16/28

(52) U.S. Cl. CPC G06F 16/24522; G06F 16/24578; G06F 16/285

(57) ABSTRACT

A system includes a processor that is configured to input personal information and store the personal information in a dedicated data cloud in a secure environment, transmit a prompt to a generative artificial intelligence model, the prompt instructing the generative artificial intelligence model to generate a draft of a resume, and automatically generate the resume based on the draft, and recognize an emotional state of a user and adjust a relocation process based on the recognized emotional state.

### CROSS-REFERENCE TO RELATED APPLICATION

This application is based on and claims priority under 35 USC 119 from Japanese Patent Application No. 2025-045122 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional relocation support and career transition systems require a user to manually manage multiple complex tasks, including preparation of a professional resume, handling of numerous administrative procedures, and emotional self-management throughout the relocation process. Existing systems typically separate data storage, document generation, and emotional support, thereby imposing a heavy cognitive and operational burden on the user. Furthermore, many systems do not securely manage sensitive personal information when transmitting such information to remote servers or cloud environments, creating privacy and security risks. In addition, conventional generative artificial intelligence tools generally generate documents such as resumes in isolation and do not adapt subsequent relocation support steps to the user's emotional state or to the user's progress status. As a result, the user may experience increased stress, inefficient task planning, and delays in completing required relocation procedures. Therefore, there is a need for a system that securely manages personal information, automatically generates resumes by using a generative artificial intelligence model, recognizes the emotional state of the user, and dynamically adjusts and supports the relocation process based on the emotional state and progress of the user.

### SUMMARY

In order to solve the above-described problems, according to one aspect of the present invention, there is provided a system comprising a processor, wherein the processor is configured to input personal information and store the personal information in a dedicated data cloud in a secure environment, transmit a prompt to a generative artificial intelligence model, the prompt instructing the generative artificial intelligence model to generate a draft of a resume, and automatically generate the resume based on the draft, and recognize an emotional state of a user and adjust a relocation process based on the recognized emotional state. The processor is further configured to use data encryption technology to securely transmit the personal information in order to input the personal information into the dedicated data cloud in the secure environment, thereby enhancing the protection of sensitive personal data during communication with the data cloud. The processor is also configured to use a prompt that instructs the generative artificial intelligence model to track a progress status of the user and to automatically propose required procedures in order to comprehensively support the relocation process, such that the system can provide context-aware and stage-appropriate guidance. By integrating secure data storage, resume generation by a generative artificial intelligence model, emotional state recognition, and automatic proposal of necessary procedures based on user progress, the system reduces the cognitive and operational burden on the user, improves efficiency and reliability in the relocation process, and provides personalized support adapted to the user's emotional condition.

The term “processor” refers to any hardware, software, or combination of hardware and software configured to execute instructions for performing the functions described in the present specification and claims, including but not limited to a central processing unit (CPU), a graphics processing unit (GPU), an application-specific integrated circuit (ASIC), a field-programmable gate array (FPGA), or a server system.

The term “personal information” refers to information related to an identified or identifiable individual user, including but not limited to name, contact information, employment history, skills, educational background, preferences, and any other data used for generating a resume or supporting a relocation process.

The term “dedicated data cloud” refers to a logically or physically isolated cloud-based storage and computing environment that is allocated for storing and processing personal information of users of the system and that is managed under predetermined security policies distinct from general-purpose cloud resources.

The term “secure environment” refers to a computing or storage environment in which data is protected by security measures such as access control, authentication, encryption, and monitoring, and in which unauthorized access, disclosure, modification, or destruction of data is restricted.

The term “generative artificial intelligence model” refers to a machine learning model or system that is trained to generate text, images, or other content in response to input data or prompts, including but not limited to large language models and other neural network-based generative models.

The term “prompt” refers to a sequence of text, data, or structured instructions that is provided as input to a generative artificial intelligence model in order to cause the model to generate specific content or to perform a specified task.

The term “draft of a resume” refers to a preliminary or intermediate version of a resume generated by the generative artificial intelligence model based on the prompt, which may subsequently be refined, completed, or formatted to constitute a final resume.

The term “resume” refers to a document or electronic record that summarizes a user's professional background, including but not limited to work experience, education, skills, qualifications, and career objectives, and that is intended for use in job applications.

The term “emotional state of a user” refers to an internal psychological condition or affective status of the user, such as stress, anxiety, confidence, satisfaction, or motivation, as inferred or recognized by the system from user behavior, biometric signals, input data, or other observable indicators.

The term “relocation process” refers to a sequence of tasks, procedures, and decisions associated with moving a user from one residence or region to another, including but not limited to job search activities, document preparation, visa or permit applications, housing search, and other administrative or logistical actions.

The term “data encryption technology” refers to any cryptographic technique or algorithm that transforms data into an encoded form that is unintelligible to unauthorized parties, and that can be decoded only by entities that possess appropriate decryption keys or credentials.

The term “progress status of the user” refers to a state or level of completion of one or more tasks, milestones, or stages within the relocation process or related procedures, as tracked or inferred by the system based on stored data and user interactions.

The term “required procedures” refers to actions, tasks, applications, submissions, or other operational steps that are necessary or recommended for the user to complete the relocation process, such as preparing specific documents, scheduling appointments, submitting forms, or contacting relevant organizations.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

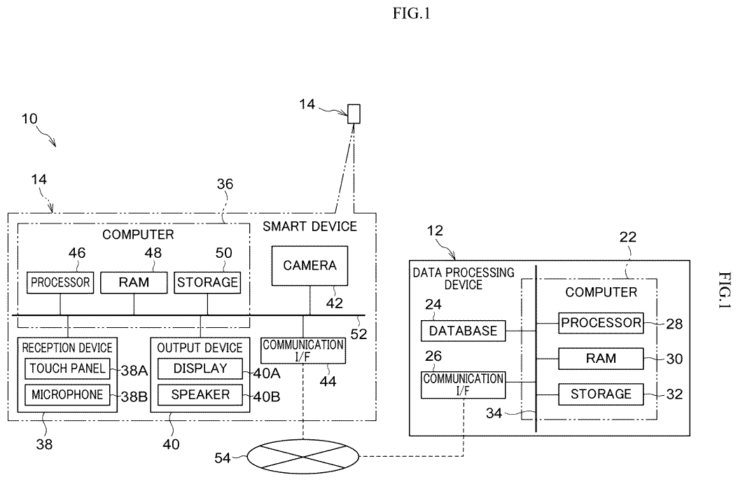

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

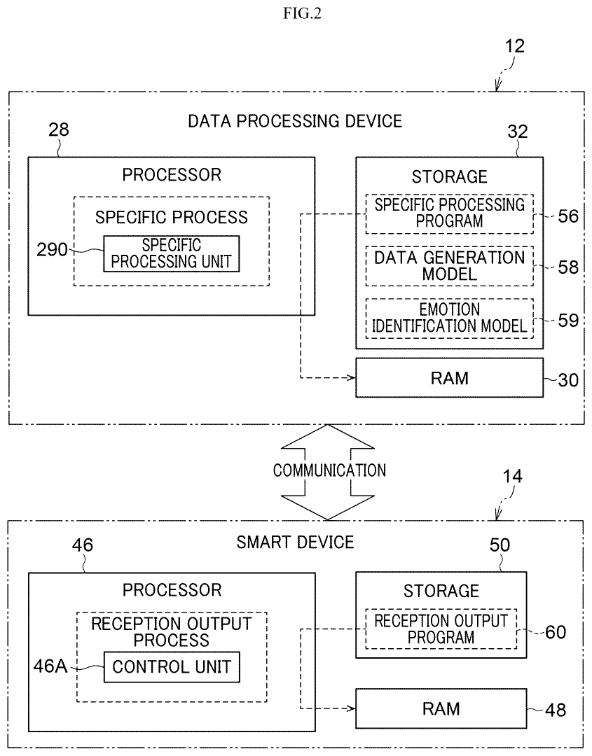

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional job recommendation and relocation support systems generally rely on static rule-based matching between user profiles and job postings. Such systems typically store user information in simple data records and directly execute database queries based on predefined filters such as job title, location, and skills. These approaches suffer from several technical limitations.

First, conventional systems do not effectively transform heterogeneous, free-text user data (for example, narrative work histories, unstructured skill descriptions, and loosely expressed preferences) into a machine-usable representation optimized for downstream search and retrieval. As a result, the systems frequently fail to capture nuanced relationships between user experience and job requirements, leading to low-quality ranking and poor retrieval precision.

Second, even when a generative AI model is introduced, it is often used merely to generate human-readable content, without being integrated as a dynamic control component for generating machine-oriented prompt sentences that drive search queries. This results in suboptimal use of the generative AI model's capabilities and does not materially improve the underlying information retrieval processes executed by the computing infrastructure.

Third, conventional architectures do not tightly couple secure data management, AI-based preprocessing, and job retrieval. Personal information may be transmitted and stored without sufficient integration of encryption and access control in a unified processing pipeline. This leads to technical challenges in maintaining confidentiality and integrity of user data across all stages of AI-assisted processing.

Fourth, existing systems generally treat job recommendation as a one-time or static operation, and do not adapt retrieval logic to changes in a user's progress state within a relocation process or to changes in the user's emotional state. System behavior is not dynamically controlled based on real-time behavioral or utterance analysis. Consequently, the underlying computation for query generation, ranking, and filtering does not evolve in response to temporal and affective signals, resulting in a rigid and less effective computational workflow.

Thus, there is a need for a computer-implemented system that: (i) securely acquires and stores personal attribute information; (ii) performs structured preprocessing including normalization and feature extraction to generate AI-ready representations; (iii) uses a generative AI model to generate machine-oriented prompt sentences that define search conditions; (iv) converts such prompt sentences into optimized search queries for job information retrieval; and (v) adaptively re-filters and re-ranks job information based on progress information and emotional state, thereby improving the technical performance and flexibility of the underlying information processing pipeline.

The specific processing by the specific processing unit 290 of the data processing device 12 in Example 1 is realized by the following means.

The present invention provides a server comprising a processor configured to receive, from a terminal, personal attribute information and preference conditions of a user, and to store the personal attribute information in a data storage device within a security environment; to perform preprocessing including normalization and feature extraction on the stored personal attribute information to generate input data for an information generation processing apparatus; to transmit, to a generative AI model as the information generation processing apparatus, an input text including the preprocessed personal attribute information and instructions to generate a prompt sentence that specifies search conditions for job information suitable for the user, and to acquire the prompt sentence from the generative AI model; to generate a search query for a job information storage device based on content of the acquired prompt sentence, to acquire candidate job information from the job information storage device, and to filter and rank the candidate job information based on the preference conditions of the user and a degree of skill matching; to transmit filtered and ranked job information to the terminal for presentation to the user; to record progress information of the user in the data storage device, to adjust content of a relocation process and related procedures according to the progress information, and to transmit, to the generative AI model, an input text for causing the generative AI model to generate a prompt sentence related to proposals for the relocation process; to analyze behavior information or utterance information acquired from the terminal to recognize an emotional state of the user, and to change the presented job information or proposed content of the relocation process based on an analysis result; and to perform information protection processing including encryption and access control when transmitting the personal attribute information and the progress information to the data storage device. This enables an integrated computer-implemented pipeline that securely manages personal data, transforms heterogeneous user information into AI-optimized representations, leverages a generative AI model to generate machine-oriented prompt sentences for controlling search queries, and dynamically adapts retrieval, filtering, and ranking of job information in response to user progress and emotional state, thereby improving the technical performance, flexibility, and security of job recommendation and relocation support processing executed by the server.

The term “personal attribute information” refers to information describing characteristics of a user, including basic profile data, work history, skills, qualifications, and other attributes relevant to job matching and relocation support.

The term “preference conditions” refers to constraints and desired parameters specified by a user, including at least desired job type, desired work location, working style, compensation range, and other selection preferences for job opportunities or relocation.

The term “terminal” refers to any user-operated computing device capable of network communication with a server, including but not limited to a mobile device, a tablet device, a desktop computer, or a web-enabled client device.

The term “server” refers to a computing apparatus, typically one or more network-connected computers, that executes backend processing including data reception, storage, preprocessing, AI interaction, query generation, and result distribution.

The term “data storage device” refers to one or more storage components, including databases or file storage systems, configured to store digital data such as personal attribute information, preference conditions, progress information, and job information.

The term “security environment” refers to a controlled computing environment in which data is protected using technical measures including encryption, access control, and secure communication protocols to maintain confidentiality, integrity, and availability of stored and transmitted information.

The term “preprocessing” refers to one or more operations performed on raw input data to convert the data into a form suitable for further processing by an information generation processing apparatus, including at least normalization and feature extraction.

The term “normalization” refers to a data processing operation that transforms heterogeneous or inconsistent data into a standardized representation, for example by unifying formats of dates, locations, and job titles, or by standardizing text representation.

The term “feature extraction” refers to a data processing operation that identifies and derives structured features from raw data, including but not limited to extracting skill keywords, experience levels, or other attributes from free-text user input.

The term “information generation processing apparatus” refers to a computational mechanism that generates new information or textual content from input data, including in particular a generative AI model.

The term “generative AI model” refers to a machine-learned model, such as a large language model, configured to generate output text in response to input text, based on parameters learned from training data.

The term “input text” refers to a sequence of one or more characters, tokens, or textual segments provided to a generative AI model, including instructions, context information, and embedded user-related data.

The term “prompt sentence” refers to a text output generated by a generative AI model that expresses machine-oriented search conditions or procedural instructions, and that is used to control subsequent information retrieval or process proposals.

The term “job information” refers to data items representing employment opportunities, including attributes such as job title, required skills, location, employment type, compensation range, and job description.

The term “job information storage device” refers to a data storage device that stores job information records and that can be queried by a server to retrieve candidate job information.

The term “search query” refers to a structured representation of search conditions, such as a database query or search engine query, generated by the server based on the prompt sentence and configured to retrieve relevant job information from the job information storage device.

The term “candidate job information” refers to a set of job information records retrieved from the job information storage device in response to a search query prior to final filtering or ranking.

The term “filtering” refers to a processing operation that selects or discards candidate job information records based on conditions such as user preference conditions, required skill sets, or mandatory constraints.

The term “ranking” refers to a processing operation that orders candidate or filtered job information records according to a relevance measure, which may depend on preference conditions, degree of skill matching, progress information, or emotional state.

The term “degree of skill matching” refers to a measure indicating how well a set of skills required or preferred in job information corresponds to the skills contained in the personal attribute information of the user.

The term “progress information” refers to data representing a temporal or state-based status of the user with respect to a process, including at least stages of a job search, application, interview, or relocation process.

The term “relocation process” refers to a sequence of activities and procedures associated with moving residence or work location, including but not limited to visa procedures, housing search, transportation arrangements, and administrative registrations.

The term “behavior information” refers to data indicative of user actions observable through the terminal, including interaction logs, navigation patterns, input timing, and selection behavior.

The term “utterance information” refers to data representing verbal or textual expressions by the user, including voice input converted to text, chat messages, or other natural-language input captured via the terminal.

The term “emotional state” refers to an inferred affective condition of the user, such as stress, anxiety, satisfaction, or confidence, estimated by analyzing behavior information and/or utterance information.

The term “information protection processing” refers to one or more security operations applied to data, including encryption, decryption, access control, authentication, and authorization, for protecting data during storage or transmission.

The term “encryption” refers to a transformation of data using a cryptographic algorithm and one or more keys, such that the transformed data is unintelligible without corresponding decryption, in order to protect confidentiality.

The term “access control” refers to a mechanism that restricts access to data or processing functions based on user identity, role, permission level, or authentication status.

The term “confidentiality” refers to a security property whereby information is protected from unauthorized disclosure.

The term “integrity” refers to a security property whereby information is protected from unauthorized modification, ensuring that stored and transmitted data remains accurate and unaltered.

In one embodiment, a server, a terminal, and a user cooperate over a communication network to implement the claimed system. The server is realized by one or more physical computing devices, each including at least one processor, a main memory, a storage device, and a network interface. The terminal is realized by a user-operated computing device such as a smartphone, a tablet device, or a personal computer, each including at least a processor, a display, an input unit, and a network interface. The user operates the terminal to provide input data and to receive output data from the server.

The server implements backend logic using an operating system, an application framework, a database management system, and an AI processing framework. For example, the server uses a server-side framework such as a generic web application framework, a database management system such as a relational database or a key-value store, and a machine learning framework such as a generic deep-learning library. The server also uses a secure communication protocol such as a transport layer security protocol to establish an encrypted channel with the terminal.

The server stores personal attribute information and progress information in a data storage device operating in a security environment. The server implements access control by associating each user with an authentication token, and by verifying the token at the time of each access to the data storage device. The server applies encryption to the stored information, for example by using a symmetric encryption scheme, and by storing encryption keys in a protected key management component. This arrangement improves data management and security because the personal attribute information and progress information are never stored or transmitted in clear text outside of the protected environment, thereby reducing the risk of unauthorized disclosure and tampering.

The server preprocesses personal attribute information before supplying it to a generative AI model. The server uses a specific data structure to represent a user profile, for example, a structured record containing fields such as a normalized skill list, a numeric representation of experience, and a normalized representation of desired job attributes. The server applies normalization operations such as converting free-text dates into a standard timestamp format, mapping various textual expressions of a skill into a canonical skill label, and converting job titles into entries in a controlled vocabulary. The server further performs feature extraction by parsing free-text work history and skill descriptions and by extracting tokens that correspond to skills, industries, seniority levels, and technical domains. The server uses natural language processing techniques such as tokenization, part-of-speech tagging, named-entity recognition, and keyword matching implemented by a natural language processing library. The server maps the extracted features into a feature vector space, for example by using a neural embedding model that converts textual segments into fixed-dimensional numeric vectors.

The generative AI model is implemented by a neural network architecture, for example a transformer-based language model including a plurality of self-attention layers, feed-forward layers, layer-normalization layers, and embedding layers. The model stores learned parameters in the form of weight matrices and bias vectors. During inference, the server supplies an input text to the generative AI model, and the model performs a series of matrix multiplications, non-linear activations, and attention computations to produce an output token sequence, which the server interprets as a prompt sentence. The model has been trained beforehand on a large corpus of text by minimizing a loss function such as a cross-entropy loss that measures the difference between predicted token distributions and actual token distributions. During training, the model performs backpropagation to compute gradients of the loss with respect to the parameters and updates the parameters using an optimization algorithm such as a stochastic gradient descent variant. In some embodiments, the server performs additional fine-tuning of the generative AI model using domain-specific data containing examples of job-search instructions and relocation-support instructions, thereby adapting the model to generate prompt sentences tailored to job information retrieval. The server constructs the input text for the generative AI model by combining a system instruction portion, a profile summary portion, and a constraint portion. The system instruction portion instructs the generative AI model to produce a concise, machine-oriented prompt sentence. The profile summary portion contains normalized and structured information describing the user's skills, experience, desired job role, and desired location. The constraint portion optionally specifies additional conditions such as salary range or working style. Because the server constructs the input text according to a predefined template and inserts normalized elements into specific positions, the input text exhibits a predictable structure that improves the stability and accuracy of the generative AI model's output. An example of such an input text is as follows:
“You are an assistant that generates precise job search instructions for a job information retrieval system. The user profile is: 3 years of web development experience, skills: Python, React, cloud computing platform, desired role: software engineer, desired location: Tokyo. Based on this profile, generate one concise prompt sentence that instructs a job database to search for suitable job postings. Focus on required skills, experience level, and preferred location.”

In response, the generative AI model outputs a prompt sentence such as: “Search for mid-level software engineer positions in Tokyo that require Python, React, and cloud computing platform experience, and that match approximately 3 years of professional web development background.”

The server parses this prompt sentence using a deterministic parsing algorithm. The server identifies semantic elements such as job title, experience level, location, and required skills by matching tokens against predefined dictionaries and part-of-speech patterns. For example, the server recognizes “software engineer” as a job title, “Tokyo” as a location, “Python, React, and cloud computing platform” as a skill list, and “3 years” as an experience duration. The server maps these elements into a query structure defined for a job information storage device. When the storage device is a relational database, the server constructs a structured query including selection conditions and ordering criteria. When the storage device is a search index such as a full-text search engine, the server constructs a query object including filter fields, score boost parameters, and similarity thresholds. This processing converts an unstructured prompt sentence into a structured and executable query, which advances computer technology by enabling a generative AI model to indirectly but precisely control a search engine through a defined translation layer.

The server then obtains candidate job information by executing the constructed query against the job information storage device. The job information storage device stores each job posting as a record containing fields such as title, location, required skills, description, and compensation information. The server retrieves a list of candidate job postings along with associated relevance scores. The server applies an additional filtering and ranking step based on the user's normalized preference conditions and the degree of skill matching between the user profile and each job posting. The server computes a skill-matching score by comparing the skill vector derived from the user profile with the skill vector derived from the job posting, for example using a cosine similarity metric. The server combines this skill-matching score with the relevance score from the search engine and with penalty factors derived from constraint violations (such as a mismatch of location or employment type) to compute a final ranking score. This multi-criteria scoring method improves the precision and recall of job retrieval compared with simple rule-based filters, and it exploits the numeric representations and vector operations that are characteristic of computer-based information processing.

The server further uses the generative AI model to generate prompt sentences related to a relocation process. The server records progress information such as which stage of job search, application, interview, housing search, or visa preparation the user is in, and stores this progress information as structured state data. The server constructs an input text for the generative AI model that includes this progress information and requests a prompt sentence that specifies procedural suggestions appropriate to the current state. For example, the server uses an input text such as:
“The user has received two job offers in the target city, has not yet selected housing, and has not yet started visa procedures. Generate one concise prompt sentence instructing a relocation support system to prioritize proposing housing options near potential workplaces and to list required visa documents.”

The generative AI model outputs a prompt sentence such as:
“Prioritize recommending rental housing near the workplaces of the two job offers and generate a checklist of required visa documents and application steps for relocation to the target city.”

The server interprets such a prompt sentence as a machine-oriented instruction and can use it to query other specialized databases, such as a housing information database or a procedural knowledge base, or to trigger workflows executed by external systems. This integrated design allows the server to adaptively control multiple backend subsystems using generated prompt sentences, which provides a technical improvement over conventional static rule systems because the control logic can be refined by retraining or reconfiguring the generative AI model without modifying the procedural code of each subsystem.

The server also recognizes an emotional state of the user by analyzing behavior information and utterance information received from the terminal. The terminal transmits behavioral logs, such as page dwell time, frequency of revisiting certain job postings, or repeated modification of preference conditions, and transmits utterance information such as chat messages or speech converted into text. The server uses a text classification model, such as a neural network classifier with an embedding layer and multiple dense layers, to infer emotion categories from utterance information. The server also uses a rule-based or machine-learned model to estimate stress or confusion from behavior patterns, such as unusually long decision times or rapid switching between screens. The server combines outputs from these models to determine an emotional state label, for example “high stress,” “low confidence,” or “high satisfaction.” Based on the emotional state, the server adjusts query parameters for job retrieval, such as narrowing or broadening search conditions, or changes the style and quantity of presented information, such as providing shorter summaries when stress is detected.

This emotional-state-dependent adjustment of computational parameters improves the efficiency of data retrieval and display. For example, when the server determines that the user is experiencing decision fatigue, the server reduces the number of job postings returned per page and selects only those postings with a high composite relevance score, thereby reducing information overload and network transfer volume. This constitutes more than mere presentation of information because the emotional state directly influences the internal query generation and ranking algorithms and results in measurable changes in computational resource usage and communication load.

The system thereby provides several technical effects. Because the server performs normalization and feature extraction into structured representations and vectors before invoking the generative AI model, and because the server translates prompt sentences into structured search queries, the system improves search precision and recall while reducing redundant database accesses. The server can cache specific prompt-to-query mappings and reuse them for similar profiles, reducing processing time. By controlling the generative AI model through templates and normalization, the server reduces variability in outputs, which simplifies downstream parsing and lowers error rates in query generation. These characteristics improve the robustness and throughput of the information retrieval pipeline compared with naive text-based search or purely manual query construction.

In another embodiment, the server hosts the generative AI model locally on specialized hardware such as a graphics processing unit device or a tensor processing device. The server configures the model with quantized parameters or pruned layers to reduce memory footprint and inference time. The server further performs batch inference for multiple users by aggregating several input texts into a single batch, thereby reducing the number of hardware context switches and improving overall processing efficiency. This embodiment shows that the claimed system is tied to a specific improvement in computer performance, namely optimized resource utilization and reduced latency in AI-driven retrieval workflows.

In yet another embodiment, the server uses different generative AI models for different purposes. A first model, specialized for job search instructions, generates prompt sentences for job information retrieval, while a second model, specialized for relocation procedures, generates prompt sentences for procedural support. The server selects which model to use based on the type of input and the current stage of the progress information. The server stores model selection rules in a configuration module and updates these rules based on measured performance metrics, such as retrieval accuracy or user completion rate. This modular design allows independent upgrading or replacement of each model without changing the overall data flow, enhancing the maintainability and scalability of the system.

The terminal can be implemented as a web application running in a browser or as a native mobile application. The terminal displays input forms for personal attribute information and preference conditions, and displays lists and details of job postings returned by the server. The terminal may locally perform lightweight validation of user input to reduce unnecessary network traffic, for example by checking mandatory fields or format validity before sending data to the server. However, the main technical contributions of the system reside in the server-side processing, in particular in the coordinated use of generative AI models, structured preprocessing, secure storage, and query translation.

The user interacts with the terminal by entering personal attribute information, confirming recommended job postings, and optionally providing free-text comments or questions. When the user modifies preference conditions, the server updates stored data structures and may recompute vector representations and query parameters. By designing the system so that the generative AI model operates on normalized and structured representations, and by translating the resulting prompt sentences into explicit query structures, the system transforms abstract user requirements into concrete internal data manipulations. This transformation is not a mere automation of human thought; instead, it leverages high-dimensional vector computations, probabilistic modeling, and dynamic control of search algorithms, which are inherently machine-centric and produce improvements in computational accuracy and efficiency.

In sum, the system provides a concrete implementation in which the server, terminal, and user collaborate through specific data structures, processing algorithms, and AI model interactions to achieve secure, precise, and adaptive job recommendation and relocation support. The generative AI model is utilized as an integrated component that generates prompt sentences guiding internal query and workflow control, and the server's design around normalization, feature extraction, emotion-aware adjustment, and resource-optimized inference leads to tangible improvements in computer technology, including improved retrieval accuracy, reduced communication load, reduced processing latency, and enhanced robustness of AI-assisted information processing.

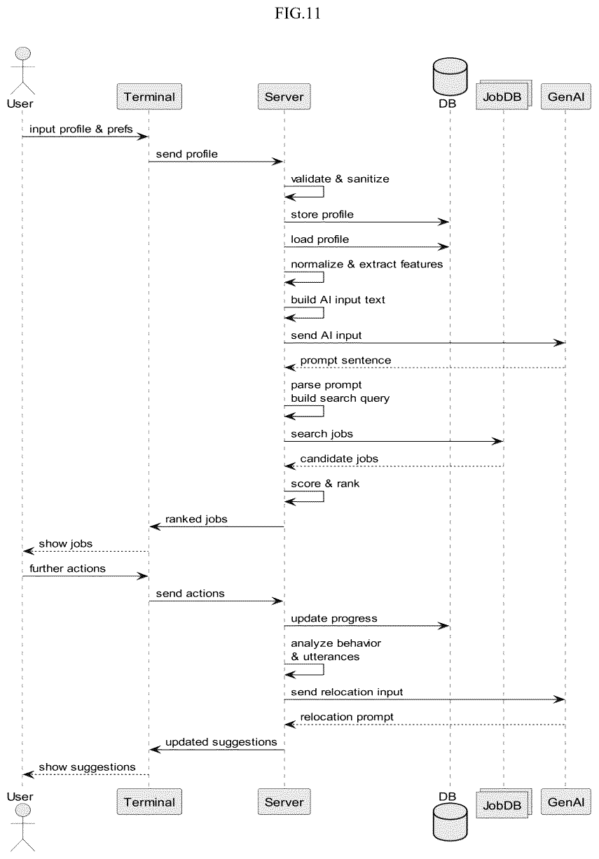

The following describes the processing flow using FIG. 11.

### Step 1:

User operates the terminal to open an input screen and enter personal attribute information and preference conditions.

User provides as input free-text values such as name, work history, skills, desired job role, desired location, and optional salary and working-style preferences.

Terminal receives this input, performs local checks such as required-field validation and simple format validation (for example, email pattern or numeric values), and then converts the validated input into a structured internal representation.

Terminal outputs a structured data object containing fields for basic profile, normalized lists of skills and preferences, and sends this object as a request payload toward the server.

### Step 2:

Terminal transmits the structured user data to the server over a secure communication channel.

Terminal uses a network protocol to send an encrypted request containing the structured user data and an authentication token.

Server receives the encrypted request as input, decrypts the payload, and verifies the authentication token against an authentication module.

Server outputs a verified, parsed data structure representing the user profile and preference conditions, suitable for subsequent server-side processing.

### Step 3:

Server validates and sanitizes the received personal attribute information and preference conditions.

Server takes as input the parsed user profile structure and a predefined schema describing valid fields, data types, and constraints.

Server performs data-format validation, checks for missing or inconsistent values, and sanitizes text fields by escaping or removing dangerous characters to prevent injection attacks.

Server outputs a cleaned, schema-compliant user profile object; if validation fails, server outputs an error response to the terminal indicating specific issues.

### Step 4:

Server stores the validated personal attribute information and preference conditions in a data storage device within a security environment.

Server takes as input the cleaned user profile object and associated user identifier.

Server encrypts sensitive fields using an encryption algorithm, applies access-control policies based on the user identifier, and writes the resulting encrypted record into a database table or collection.

Server outputs a storage confirmation and maintains an index entry that links the user identifier to the stored encrypted record for later retrieval.

### Step 5:

Server retrieves stored user data and constructs a normalized profile representation for AI preprocessing.

Server takes as input the user identifier and a retrieval request initiated by internal logic or a new user action.

Server queries the data storage device, decrypts encrypted fields, and combines basic profile data, work history, skills, and preference conditions into a single in-memory representation.

Server outputs a unified user profile record containing all relevant fields for preprocessing.

### Step 6:

Server performs normalization on the unified user profile to produce standardized textual and numeric fields.

Server takes as input the unified user profile record with raw text and heterogeneous formats.

Server converts date strings to timestamp formats, maps variant skill expressions to canonical skill names using a skill dictionary, standardizes job titles against a controlled vocabulary, and converts location names to standardized region codes.

Server outputs a normalized user profile object wherein all key fields are expressed in a consistent and machine-readable format.

### Step 7:

Server performs feature extraction to derive structured features and vector representations from the normalized user profile.

Server takes as input the normalized profile object, including free-text descriptions of work history and skills.

Server tokenizes text, performs part-of-speech tagging, extracts skill keywords and domain-specific terms, and maps them to feature indices; the server then uses an embedding model to transform textual segments into fixed-length numeric vectors.

Server outputs a feature-enhanced profile structure containing both symbolic features (such as skill lists and experience levels) and numeric vectors representing semantic content.

### Step 8:

Server constructs an input text for the generative AI model using the feature-enhanced profile and a predefined instruction template.

Server takes as input the feature-enhanced profile structure and a template specifying how to describe the user profile and constraints to the generative AI model.

Server generates a profile summary sentence, inserts normalized skills, experience, desired role, and desired location into the template, and appends instructions asking for a single concise prompt sentence suitable for controlling a job search system.

Server outputs a complete input text that serves as the request content for the generative AI model.

### Step 9:

Server transmits the constructed input text to the generative AI model and receives a prompt sentence.

Server takes as input the constructed input text and model configuration parameters such as maximum output length and decoding strategy.

Server sends the input text to a transformer-based generative AI model, which performs internal computations (attention operations, matrix multiplications, and non-linear transformations) using trained parameters to predict the next tokens; the model iteratively generates a sequence of tokens that forms a prompt sentence.

Server outputs the generated prompt sentence as a text string, such as “Search for mid-level software engineer positions in Tokyo that require Python, React, and cloud computing platform experience, and that match approximately 3 years of professional web development background.”

### Step 10:

Server validates and refines the generated prompt sentence for completeness and compliance. Server takes as input the prompt sentence text and a set of validation rules specifying required elements such as job title, location, and skills.

Server checks whether the prompt sentence contains identifiable job role terms, location terms, and skill terms; if necessary, server truncates excessive content, removes disallowed personal identifiers, and ensures that the sentence fits within predetermined length constraints.

Server outputs a refined prompt sentence that is safe, concise, and structurally suitable for subsequent parsing and query construction.

### Step 11:

Server parses the refined prompt sentence into a structured search specification.

Server takes as input the refined prompt sentence and a parsing configuration including dictionaries for job titles, skill names, and location names.

Server applies tokenization and pattern matching to identify segments corresponding to job role, required skills, location, and experience level; the server then maps each segment to standardized fields, such as “role,” “locations,” “required_skills,” and “minimum_experience.”

Server outputs a structured search specification object that encodes the search conditions in a format independent of any particular database engine.

### Step 12:

Server converts the structured search specification into a concrete search query for a job information storage device.

Server takes as input the structured search specification and metadata describing the schema of the job information storage device.

Server constructs a database query or search engine query object, defining filters for location and employment type, match conditions for required skills, and scoring functions that boost postings with high skill overlap and appropriate experience level.

Server outputs an executable search query tailored to the underlying job information storage device, such as a parameterized SQL query or a full-text search query object.

### Step 13:

Server executes the search query against the job information storage device and retrieves candidate job information.

Server takes as input the executable search query and connection parameters for the job information storage device.

Server sends the query to the storage device, receives a list of job records satisfying the query, and reads fields such as title, company identifier, location, required skills, and description, along with any relevance scores computed by the storage device.

Server outputs a candidate job list containing multiple job records with associated preliminary relevance scores.

### Step 14:

Server computes refined relevance scores for the candidate job information using skill matching and user preference conditions.

Server takes as input the candidate job list and the feature-enhanced profile structure of the user.

Server derives a skill vector for each job by mapping required and preferred skills to the same feature space as the user's skill vector, then computes similarity measures such as cosine similarity to determine the degree of skill matching; the server combines this similarity with constraint satisfaction indicators (such as location match and job type match) to calculate a composite relevance score for each job record.

Server outputs a scored job list in which each candidate job is associated with an updated, composite relevance score reflecting both system-retrieved relevance and user-specific feature matching.

### Step 15:

Server ranks and filters the scored job list to produce a final selection of job information to present.

Server takes as input the scored job list and optional parameters such as a minimum acceptable relevance score and a maximum number of results.

Server sorts the job records in descending order of composite relevance score, removes records whose score falls below the threshold or that violate mandatory constraints, and optionally limits the result set to the top N jobs.

Server outputs a filtered and ranked job list, ready for transmission to the terminal.

### Step 16:

Server formats the filtered and ranked job list into a response message for the terminal.

Server takes as input the filtered and ranked job list and a formatting specification defining which fields to include in the response.

Server extracts essential fields such as job title, location, key required skills, and summary description, and arranges them into a structured response format, while omitting internal scoring details that are not necessary for display.

Server outputs a response message containing the selected job information in a structured but compact form.

### Step 17:

Server transmits the formatted job information to the terminal, and terminal prepares display data.

Server takes as input the formatted response message and an address associated with the requesting terminal.

Server sends the response message over the secure communication channel; terminal receives the response as input, parses the structured data, and maps fields such as job title and location to user interface elements such as list entries or detail views.

Terminal outputs a set of display-ready records, which it holds in memory for graphical rendering.

### Step 18:

Terminal displays the ranked job information to the user and accepts further user interactions.

Terminal takes as input the display-ready records and layout definitions describing how to render lists, cards, or detail pages.

Terminal draws user interface components, populates them with text fields such as job titles and locations, and renders navigation elements allowing the user to view details or adjust preference conditions; terminal also collects new user actions, such as selecting a job or initiating another search.

User views the presented information and provides new input, which terminal outputs as updated interaction data for subsequent processing by the server.

### Step 19:

Server records progress information and updates the user's state related to job search and relocation.

Server takes as input interaction data from the terminal, such as job selections, application confirmations, or relocation-related choices.

Server interprets these actions as state transitions in a predefined progress model, updates progress fields in the user's record (for example, marking specific stages as completed), and writes the updated progress information to the data storage device under secure conditions.

Server outputs an updated progress state that is available for use in further generative AI model inputs and adaptive query adjustments.

### Step 20:

Server analyzes behavior and utterance information to infer the user's emotional state and adjusts subsequent processing.

Server takes as input logs of user behavior from the terminal, such as dwell times and navigation patterns, as well as utterance texts from chats or transcribed speech.

Server applies a classification algorithm using text embeddings and behavioral features to assign an emotional-state label, and uses this label to adjust parameters such as the breadth of search conditions, the number of results returned, or the style of explanatory text included in responses.

Server outputs modified internal parameters and control signals that influence future generative AI model input texts and query generation, thereby adapting the computational behavior of the system to the inferred emotional state.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional computer-implemented job recommendation and relocation support systems suffer from several technical limitations that restrict their effectiveness and scalability. First, many existing systems rely on static rule-based matching or simple keyword search over user profiles and job postings. Such systems typically operate on minimally processed text and structured fields, and do not exploit advanced machine learning models or generative AI models. As a result, the systems are unable to flexibly adapt recommendation logic to complex or evolving user attributes, and cannot automatically generate high-quality resume drafts or explanatory information without extensive manual configuration.

Second, existing systems generally treat prompt sentences for generative AI models as fixed or manually designed templates. These static prompts are not dynamically optimized based on accumulated user data or prior recommendation results. Consequently, the systems fail to leverage the large volume of stored personal information and job candidate information to improve prompt construction over time, leading to suboptimal utilization of generative AI models and degraded quality of generated resumes, job recommendations, and procedural guidance.

Third, conventional systems typically do not integrate user emotional state estimation into the control flow of job recommendation and relocation processes. User interfaces and backend processing often present recommendation results and procedural tasks in a uniform manner, without adjusting timing, content density, or explanatory detail according to the user's emotional condition inferred from operation information, biological information, or behavior information. This uniform presentation can overwhelm users, reduce engagement with the system, and cause inefficiencies in the progression of relocation processes or job selection processes.

Fourth, existing systems often require users or operators to manually identify and input necessary procedures related to relocation or job change, such as visa applications, housing search tasks, or contract steps. These manual flows are error-prone and do not scale well when many users with diverse backgrounds and progress states are handled. The systems do not automatically generate, using a generative AI model, context-specific procedural proposals based on stored progress information and job candidate information, and therefore cannot reduce cognitive load on users or improve throughput of the overall process.

Accordingly, there is a need for an improved computer-implemented system that (i) performs structured preprocessing of personal information for use with a generative AI model, (ii) automatically and dynamically generates optimized prompt sentences based on accumulated data, (iii) integrates user emotional state estimation into the timing and content control of job recommendation and relocation support, and (iv) automatically generates and presents necessary procedures using the generative AI model based on user progress information and job candidate information. Such a system should improve the functioning of the computer itself by enabling more efficient use of processing, storage, and generative AI resources, by reducing redundant interactions, and by guiding users through complex processes in a technically adaptive manner.

The specific processing by the specific processing unit 290 of the data processing device 12 in Application Example 1 is realized by the following means.

The present invention provides a server comprising a processor configured to control presentation of an operation screen on a communication terminal to receive personal information including basic attributes, employment history, capability information, and job preference conditions; to acquire the personal information via a communication line and store the personal information in a dedicated data storage device in a security environment using encrypted communication; to acquire the stored personal information, perform text normalization processing and attribute conversion processing on the personal information to generate preprocessed information, and automatically generate a prompt sentence for causing a generative AI model to generate a draft of a resume based on the preprocessed information; to input the prompt sentence and the preprocessed information to the generative AI model, obtain job candidate information including the draft of the resume from the generative AI model, analyze the job candidate information to calculate a degree of compatibility with the personal information, rank the job candidate information based on the degree of compatibility, and present a ranked job recommendation result to the communication terminal; to estimate an emotional state of a user based on operation information and biological information or behavior information received from the communication terminal, adjust content or timing of presentation of the job recommendation result in accordance with the emotional state, and control a progress procedure of a relocation process or a job selection process; and to store procedure progress information of the user, generate a prompt sentence for causing the generative AI model to automatically propose necessary procedures based on the procedure progress information and the job candidate information, and present proposal contents of the necessary procedures to the communication terminal. This enables an adaptive computer-implemented recommendation and relocation support architecture in which the server optimizes prompt sentences and data flows for a generative AI model, dynamically controls user interface outputs based on inferred emotional state and progress data, and thereby improves overall computational efficiency, relevance, and user interaction quality beyond conventional static job matching systems.

The term “processor” refers to a hardware-based or virtual computing element, such as a central processing unit or a processing core of an information processing apparatus, that executes instructions to perform data acquisition, data storage, data preprocessing, model inference control, analysis, and presentation control in the system.

The term “communication terminal” refers to an electronic device, such as a portable terminal or a stationary terminal, that includes at least a display unit, an input unit, and a communication interface, and that is configured to transmit and receive data to and from the server over a communication network.

The term “operation screen” refers to a graphical user interface or other user interface presented on a display of the communication terminal, through which a user inputs information, issues commands, and confirms outputs provided by the system.

The term “personal information” refers to information related to an individual user, including at least basic attributes, employment history, capability information, and job preference conditions, that is used by the system for generating resumes, job recommendations, and procedural proposals.

The term “basic attributes” refers to general profile information about a user, such as demographic attributes, identification attributes, and contact attributes, which are used as part of the personal information for processing by the system.

The term “employment history” refers to historical information about a user's past or current occupations, including at least job roles, periods of employment, organizational types, and work responsibilities, which are used by the system to infer suitable job candidates and generate resume content.

The term “capability information” refers to information describing a user's skills, knowledge, qualifications, certifications, or other competencies that are relevant to job matching and resume generation.

The term “job preference conditions” refers to constraints or desired attributes specified by a user regarding future work, such as preferred job categories, industries, working styles, locations, and compensation ranges.

The term “communication line” refers to a wired or wireless communication path, including at least a network connection provided by a communication network, through which data is transmitted between the communication terminal and the server.

The term “dedicated data storage device” refers to a storage subsystem, such as a database system or a non-transitory storage medium cluster, that is logically or physically isolated for storing personal information and related data used by the system.

The term “security environment” refers to a computational and storage environment that applies one or more security controls, such as access control, encryption, and monitoring, to protect stored and transmitted information from unauthorized access or modification.

The term “encrypted communication” refers to a communication method in which transmitted data is transformed by a cryptographic algorithm so that the data is unreadable to unauthorized entities during transmission over the communication line.

The term “text normalization processing” refers to processing that converts text data into a standardized form, including operations such as character conversion, case normalization, removal of unnecessary symbols, and unification of synonymous expressions.

The term “attribute conversion processing” refers to processing that transforms raw input attributes into standardized or encoded attributes, including at least mapping to controlled vocabularies, categorization, and numerical encoding for use in machine learning or model input.

The term “preprocessed information” refers to personal information and related data after application of text normalization processing and attribute conversion processing, which is structured or encoded for efficient use by the generative AI model.

The term “prompt sentence” refers to a piece of machine-readable or human-readable text, which may include structured or semi-structured content, that is input to a generative AI model to specify a task, desired output, or constraints, such as generation of a resume draft or procedural proposals.

The term “generative AI model” refers to a machine learning model capable of generating text or structured data based on an input prompt sentence and optional contextual information, and includes, for example, a neural network-based language model.

The term “resume draft” refers to a machine-generated textual representation of a user's professional profile, including at least employment history, capabilities, and other relevant items, which may be further edited by the user to form a finalized resume.

The term “job candidate information” refers to information generated by the generative AI model that represents one or more potential job options or job categories relevant to the user's personal information, and may include associated attributes such as required skills, work style, and location.

The term “degree of compatibility” refers to a numerical value or qualitative metric computed by the processor that indicates how well a particular job candidate information item matches the personal information of the user.

The term “ranked job recommendation result” refers to an ordered list or set of job candidate information items that is sorted based on the degree of compatibility or other relevance metrics and is presented to the user through the communication terminal.

The term “operation information” refers to information derived from user interactions with the communication terminal, such as input timing, input frequency, selection patterns, and navigation behavior in the operation screen.

The term “biological information” refers to information related to a user's physical or physiological state that can be acquired by the communication terminal or a connected device, such as heart rate, facial expression features, or other sensor-derived indicators.

The term “behavior information” refers to information related to a user's behavior patterns, such as movement, posture, or usage patterns, that can be detected or inferred by sensors or software of the communication terminal or associated devices.

The term “emotional state” refers to an estimated psychological condition of the user, such as stress level, engagement level, or satisfaction level, inferred by the processor based on operation information, biological information, or behavior information.

The term “relocation process” refers to a sequence of tasks or procedures associated with changing a user's place of residence or work location, including but not limited to administrative, logistical, and housing-related steps.

The term “job selection process” refers to a sequence of steps by which a user evaluates and chooses among job candidate information items, including reviewing recommendations, examining details, and making application decisions.

The term “procedure progress information” refers to information that represents a current status or history of completion of tasks or procedures related to the relocation process or job selection process for a user.

The term “necessary procedures” refers to tasks or actions that are determined, based on procedure progress information and job candidate information, to be required or appropriate for advancing the relocation process or job selection process for a user.

The term “proposal contents of the necessary procedures” refers to output information generated by the generative AI model and processed by the processor that describes recommended necessary procedures, including their descriptions, priorities, and suggested execution timing, for presentation on the communication terminal.

In one embodiment, a server cooperates with a terminal to implement a system for generating resume drafts, job candidate information, and procedure proposals by using a generative AI model. The server includes at least one processor, a main memory, a non-transitory storage device, and a network interface. The terminal includes a display, an input unit, a communication interface, and optionally one or more sensors for acquiring biological information or behavior information.

The server executes application software implemented, for example, using a server-side framework, a relational database management system, and a machine learning framework such as a numerical computation library and a deep learning library. The server stores personal information, job candidate information, and procedure progress information in a dedicated data storage device configured as a secure logical partition of one or more storage systems, such as a relational database and an object storage system. The server enforces access control, encryption at rest, and audit logging in the dedicated data storage device to form a security environment.

The terminal executes a client application implemented, for example, using a web application platform or a native application framework. The terminal renders an operation screen on the display. The terminal enables a user to input personal information including basic attributes, employment history, capability information, and job preference conditions. The terminal acquires operation information from the user's interaction, such as touch events, cursor movements, scrolling behavior, and input timing. When the terminal includes sensors such as a camera, a microphone, or a wearable interface, the terminal acquires biological information or behavior information such as facial expression features, voice prosody features, or motion patterns.

The server receives the personal information from the terminal via a communication line using encrypted communication, such as transport-layer encryption with session key negotiation. The server converts received data into internal data structures. In one embodiment, the server stores basic attributes, employment history, capability information, and job preference conditions in relational tables, where columns correspond to normalized fields and foreign keys associate records with a user identifier. The server stores unstructured text such as free-form job descriptions or user-provided summaries as objects in the object storage system, indexed by the user identifier and metadata.

The server applies text normalization processing to textual fields of the personal information.

The server removes markup, converts characters to a canonical form, standardizes whitespace, and performs tokenization using a natural language processing library. The server maps variations of job titles and skill names to controlled vocabularies by using a dictionary and an embedding-based similarity computation. For example, the server maps “software developer,” “software engineer,” and “backend engineer” to a canonical occupation label by computing vector representations of the terms and selecting a label with cosine similarity above a threshold. This attribute conversion processing converts heterogeneous user-provided labels to standardized attributes suitable for consistent downstream processing. The server encodes the preprocessed information into feature vectors to be used as inputs to a generative AI model and auxiliary models. In one embodiment, the server uses a deep learning library to generate dense vector representations of sentences, skills, and job descriptions. The server concatenates or otherwise aggregates these vectors into a structured feature representation representing the user's profile. The server stores these feature representations in the dedicated data storage device so that subsequent invocations of the generative AI model can reuse them without reprocessing raw text, thereby reducing computation time and communication load.

The server constructs a prompt sentence to control behavior of the generative AI model. The server uses a prompt template stored in the dedicated data storage device and fills variable portions of the template with elements derived from the preprocessed information. For example, the server constructs a prompt sentence such as:
“User profile:
Employment history: [normalized roles and periods].
Capabilities: [standardized skills and qualifications].
Job preferences: [job categories, locations, work style, compensation range].

Based on this profile, using the generative AI model, generate a draft of a resume and a ranked list of suitable job candidates. For each job candidate, output job title, required core capabilities, work style (remote or on-site), and main location.”

The server may generate additional prompt sentences for explanations and procedure proposals. For example, the server may construct:
“Given the following user profile and a specific job candidate, explain why this job candidate is suitable for the user, list the top three matching capabilities, and list up to two capability gaps.”
or
“Based on the user's current progress in relocation and job selection and the following job candidates, generate a list of necessary procedures, including administrative steps, documentation, and recommended timing.”

The server updates the prompt templates based on accumulated logs of inputs and outputs.

The server records pairs of personal information patterns and generative AI model outputs, together with user feedback and success metrics such as job acceptance or completion of procedures. The server analyzes these records offline or periodically using an optimization routine. The server adjusts wording, ordering of instructions, and explicit constraints in the prompt templates so that the generative AI model yields more structured and accurate outputs. This learning-like update of prompt templates modifies internal data structures stored in the dedicated data storage device and changes how the processor generates prompt sentences for future users. This behavior improves the efficiency of the generative AI model interaction at the system level, as the server reduces the rate of malformed outputs and post-processing errors, thereby decreasing overall computation cost and latency.

The server invokes a generative AI model implemented as a neural network. In one embodiment, the server uses a transformer-based language model with multiple self-attention layers, feedforward layers, and an output softmax layer. The server pre-trains the model or receives a pre-trained model and optionally fine-tunes it on domain-specific corpora, such as anonymized resumes, job descriptions, and procedural documents stored in the dedicated data storage device. During training, the server defines a loss function combining cross-entropy loss for next-token prediction and auxiliary losses for structural constraints, such as penalties when output deviates from a desired JSON-like structure or when mandatory fields are omitted. The server updates model weights using a stochastic gradient descent algorithm or a variant such as an adaptive optimizer.

The server uses mini-batch training on computational hardware such as a graphical processing unit or a tensor processing accelerator. The server implements a data augmentation pipeline that perturbs training examples by paraphrasing text, shuffling order of bullet points, and simulating incomplete or noisy user input. This data augmentation improves model robustness to variations in real user input. By controlling the internal architecture, loss functions, and training regimen, the server improves the ability of the generative AI model to reliably follow prompt sentences and to produce well-structured outputs, thereby enhancing computational accuracy compared to naive use of a generic language model.

At inference time, the server transmits the prompt sentence and optional feature vectors to the generative AI model. The server executes a decoding algorithm such as beam search with constraints to restrict allowed tokens for field labels and delimiters. The server may enforce structural tokens at specified positions to guarantee that the generated text contains identifiable sections for resume content, job candidate entries, and procedure descriptions. This constrained decoding reduces post-processing complexity and error rate, since the server can directly parse the model output into internal data structures without sophisticated error correction.

The server parses responses from the generative AI model and converts the responses into job candidate information, resume drafts, and procedure proposals. The server uses pattern matching and token-level validation, and when the prompts are designed for semi-structured outputs, the server uses a deterministic parser tuned to the expected field labels. The server computes a degree of compatibility between each job candidate information item and the user's feature representation. In one embodiment, the server encodes each job candidate description into a feature vector using the same embedding mechanism applied to personal information, and computes similarity by cosine similarity or a learned scoring function represented by a small neural network. The server stores compatibility scores and ranks job candidates accordingly.

The server estimates an emotional state of the user based on operation information, biological information, and behavior information. The server stores time-series vectors of interaction events, sensor-derived features, and contextual labels. The server applies a separate machine learning model, such as a recurrent neural network or a transformer configured for sequence classification, to infer an emotional state label such as “stressed,” “confident,” or “uncertain.” The server trains this emotional state model on labeled datasets where interaction patterns and sensor features are associated with known emotional states. The server uses a loss function such as cross-entropy and adjusts weights by gradient descent during training. By maintaining a dynamic estimate of the emotional state, the server adjusts presentation content and timing. For example, when the emotional state indicates overload or stress, the server reduces the number of job candidates displayed at once, delays presentation of complex procedural instructions, and increases the amount of explanatory text generated by the generative AI model. When the emotional state indicates confidence and high engagement, the server presents more options and compresses explanations. This adaptive behavior modifies the sequence and density of data transmitted to the terminal, thereby reducing unnecessary communication and user interface rendering load. This also reduces the number of redundant server requests, as users are less likely to repeatedly request clarification.

The terminal displays the ranked job recommendation result, resume draft, and procedure proposals. The terminal renders these outputs in a structured layout, such as segmented views for resume content, job candidate lists, and a timeline or checklist of necessary procedures.

The user can select a particular job candidate to view detailed information. When the user selects a job candidate, the server constructs an explanatory prompt sentence including the personal information and the specific job candidate and requests explanatory information from the generative AI model. The server parses the explanatory output and transmits it to the terminal. The terminal displays the explanatory information as justification and highlights matching capabilities and capability gaps.

The server stores procedure progress information to represent which necessary procedures a user has completed. The server updates this information when the user confirms completion of a task via the terminal or when external systems, such as document submission platforms or housing platforms, send status updates. The server uses procedure progress information together with job candidate information to generate new prompt sentences for the generative AI model, requesting updated necessary procedure lists that account for completed steps and remaining requirements. The server also re-ranks procedures based on urgency and dependencies. This re-ranking uses a directed acyclic graph stored in the dedicated data storage device, where nodes represent procedures and edges represent prerequisite relationships. The server computes a topological ordering and assigns priority scores so that users receive a technically optimized sequence of steps that reduce total time and avoid deadlocks.

The server improves computer technology by combining the above mechanisms. The server reduces processing time and resource usage by:
(1) storing preprocessed feature representations and standardized attributes, thereby avoiding repeated text normalization and encoding for each interaction;
(2) using constrained decoding and structured prompt design, reducing ambiguity in generative AI outputs and lowering post-processing complexity;
(3) dynamically updating prompt templates based on accumulated data, which improves the generative AI model's adherence to field-level constraints and reduces the number of iterations needed to obtain acceptable outputs;
(4) integrating emotional state estimation to adjust interface content and timing, thereby decreasing unnecessary server requests and smoothing resource utilization; and
(5) using graph-based procedure management to minimize redundant or conflicting instructions and to schedule communications and computations more efficiently.

The system does not merely automate human judgment but implements specific non-conventional data structures and algorithms tailored to a generative AI environment. The server uses standardized attribute vocabularies, embedding-based mappings, transformer architectures, constrained decoding, prompt template optimization, emotional state classification, and graph-based procedure scheduling. These technical arrangements cooperate to improve the operation of the server and the terminal as information processing machines. The resulting architecture provides faster convergence to accurate job and procedure recommendations, lower bandwidth consumption due to reduced back-and-forth interactions, consistent data representations across modules, and a lower error rate in generated resume drafts and procedure lists compared to conventional rule-based or naively configured AI systems.

In alternative embodiments, the server may deploy different neural network architectures for the generative AI model, such as encoder-decoder models with attention or mixture-of-experts models. The server may also vary embedding techniques, for example, by using character-level encoders or subword tokenization schemes to handle multilingual or noisy input. The server may change the emotional state model to a probabilistic graphical model or to an ensemble of classifiers. The terminal may be a wearable device, a vehicle-mounted device, or another type of communication terminal with various sensors. Regardless of such variations, the server continues to perform structured preprocessing, prompt sentence generation, constrained generative inference, compatibility scoring, emotional state estimation, and adaptive procedure proposal as described, thereby maintaining the described technical effects.

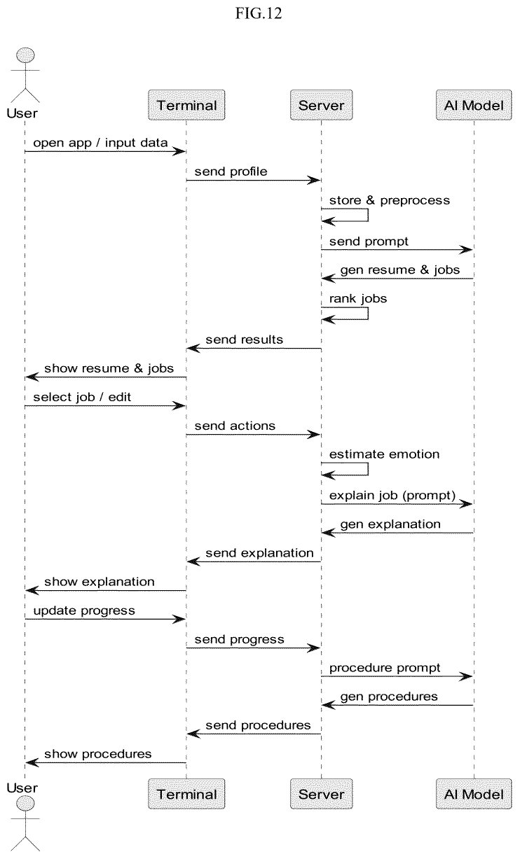

The following describes the processing flow using FIG. 12.

### Step 1:

User operates the terminal to open an application and display an operation screen for inputting personal information.

User inputs basic attributes, employment history, capability information, and job preference conditions into input fields on the operation screen.

Input: raw text and selection values entered by the user (names, dates, job titles, skills, preferred locations, desired work style, etc.).

Output: structured form data held in the terminal's local memory (for example, a key-value map or an internal object representing the personal information).

Terminal validates the form data (e.g., checks required fields, date formats, and value ranges) and converts selection values into internal codes (such as enumerated types for work style and location regions).

### Step 2:

Terminal serializes the validated personal information into a message format, such as a JSON-like structure, and prepares a transmission buffer.

Terminal establishes an encrypted communication session with the server over a communication line and transmits the serialized personal information to the server via a secure protocol.

Input: structured form data in the terminal's memory.

Output: encrypted network packets containing the serialized personal information sent to the server.

Terminal records a local timestamp and a transmission status flag for later synchronization or retry logic.

### Step 3:

Server receives encrypted packets via a network interface and terminates the secure session to obtain the serialized personal information.

Server deserializes the received data into internal data structures, such as objects with fields for basic attributes, employment history, capability information, and job preference conditions.

Input: encrypted packets containing serialized personal information.

Output: in-memory personal information records within the server, organized in predefined data structures.

Server performs schema validation and sanitization, rejecting malformed or dangerous input and logging validation errors for monitoring.

### Step 4:

Server stores the validated personal information in a dedicated data storage device within a security environment.

Server maps each field of the personal information to columns in relational tables and writes corresponding records, while unstructured text fields are saved in object storage with appropriate metadata.

Input: in-memory personal information records.

Output: persistent records in the dedicated data storage device, linked to a unique user identifier and timestamps.

Server applies encryption at rest and updates an index structure so that subsequent processes can efficiently retrieve relevant user records.

### Step 5:

Server retrieves stored personal information when analysis or generation is requested, using the user identifier as a lookup key.

Server performs text normalization processing on free-text fields (such as job descriptions and skill descriptions) by lowercasing, removing extraneous symbols, and splitting text into tokens.

Input: stored personal information records (raw text and codes) from the dedicated data storage device.

Output: normalized text tokens and cleaned field values associated with the user profile.

Server logs preprocessing status and discards or flags tokens that contain inappropriate or unusable content according to predefined rules.

### Step 6:

Server performs attribute conversion processing to standardize heterogeneous job titles and skills into canonical labels.

Server compares text tokens from the user profile against a controlled vocabulary using embedding vectors and similarity computations; when similarity exceeds a threshold, the server assigns canonical labels to the profile.

Input: normalized text tokens and existing controlled vocabularies or embedding models.

Output: standardized attributes, such as canonical job titles and skills, encoded as identifiers or category codes.

Server updates the user profile representation in memory and, optionally, stores the standardized attributes back into the dedicated data storage device for reuse.

### Step 7:

Server generates feature vectors representing the user profile by encoding normalized text and standardized attributes using a deep learning embedding module.

Server combines embeddings of employment history, capability information, and job preference conditions into a structured multi-dimensional vector representation.

Input: standardized attributes and normalized text tokens of the user profile.

Output: one or more feature vectors corresponding to different aspects of the user profile (e.g., experience vector, skill vector, preference vector). Server caches these feature vectors to avoid repetitive computation in subsequent

recommendation or explanation requests.

### Step 8:

Server constructs a prompt sentence for the generative AI model by loading a prompt template and filling in variable sections with information derived from the user feature vectors and standardized attributes.

Server generates a textual prompt, for example:
“User profile:
Employment history: [normalized roles and periods].
Capabilities: [standardized skills and qualifications].
Job preferences: [job categories, locations, work style, compensation range].

Based on this profile, using the generative AI model, generate a draft of a resume and a ranked list of suitable job candidates. For each job candidate, output job title, required core capabilities, work style (remote or on-site), and main location.”

Input: feature vectors and standardized attributes of the user profile, and a stored prompt template.

Output: a concrete prompt sentence string ready to be input to the generative AI model.

Server records the generated prompt sentence and associated user identifier in a log for later analysis and template optimization.

### Step 9:

Server sends the prompt sentence and, when supported, the associated feature vectors to the generative AI model running on specialized hardware or accessed via an inference API.

Server sets generation parameters such as maximum token length, beam width, and temperature to control the output characteristics of the generative AI model.

Input: prompt sentence text and optional user feature vectors.

Output: raw generated text from the generative AI model that includes a resume draft and a set of job candidate descriptions, or another structured textual format as specified in the prompt.

Server monitors inference time and resource usage and applies timeout or fallback strategies if necessary.

### Step 10:

Server parses the raw generated text to extract structured job candidate information and resume content.

Server identifies delimiters and field markers specified in the prompt, segments the text into individual job candidate entries, and extracts attributes such as job titles, required capabilities, work style, and locations.

Input: raw generated text from the generative AI model.

Output: a structured job candidate list and a structured resume draft, represented as internal data objects.

Server validates extracted fields, correcting minor formatting inconsistencies and discarding incomplete entries that do not meet predefined structural rules.

### Step 11:

Server computes a degree of compatibility between each job candidate and the user profile by embedding job descriptions into feature vectors and comparing them with the user feature vectors.

Server uses similarity metrics, such as cosine similarity or a learned scoring function, to assign a numerical compatibility score to each job candidate.

Input: structured job candidate information and user profile feature vectors.

Output: a list of job candidate entries with attached compatibility scores.

Server ranks the job candidate entries in descending order of compatibility score and optionally applies additional filters based on job preference conditions.

### Step 12:

Server generates a job recommendation result by selecting the top-ranked job candidate entries and combining them with the resume draft.

Server converts the ranked job candidate entries into a format suitable for transmission to the terminal, including brief summaries and identifiers for later reference.

Input: list of job candidate entries with compatibility scores and resume draft.

Output: a ranked job recommendation result and an associated resume draft, encapsulated in a response object for the terminal.

Server stores a record of the recommendation result, including timestamps and compatibility scores, in the dedicated data storage device for auditing and further optimization of prompt templates.

### Step 13:

Terminal receives the job recommendation result and resume draft from the server through the encrypted communication channel and deserializes the response object.

Terminal renders the ranked list of job candidates on the display, presenting job titles, compatibility indicators, work styles, and locations, and shows the generated resume draft in an editable view.

Input: ranked job recommendation result and resume draft from the server.

Output: a graphical user interface displaying candidate lists and resume content for user interaction.

Terminal records user interactions with the displayed elements, such as which job candidates are opened or edited, for use as operation information.

### Step 14:

User reviews the ranked job recommendation result and the resume draft on the terminal and selects one or more specific job candidates to view more detailed information.

User may modify the resume draft and approve or reject suggested edits.

Input: visual presentation of job candidates and resume content on the terminal display.

Output: user selections of job candidates and edit operations on the resume draft, which are transmitted as operation information to the server.

Terminal updates local state to reflect which entries have been viewed or edited and may send incremental updates to the server to synchronize progress.

### Step 15:

Server receives operation information from the terminal and updates internal records about viewed job candidates and resume edit status.

Server uses operation information, and optionally biological or behavior information, as input to an emotional state estimation model to infer the user's current emotional state.

Input: operation information, and optionally biological information or behavior information.

Output: an estimated emotional state label or score for the user at the current interaction stage.

Server stores the emotional state estimate together with the corresponding interaction context for later analysis and adaptive control.

### Step 16:

Server adjusts presentation parameters of subsequent outputs based on the estimated emotional state.

Server may limit the number of job candidates sent in the next response, increase explanatory detail, or alter the ordering of information to avoid overwhelming the user.

Input: estimated emotional state and current recommendation context.

Output: modified presentation instructions and filtered or restructured response content tailored to the user's state.

Server transmits updated recommendation subsets or additional explanatory text to the terminal according to the modified presentation strategy.

### Step 17:

User proceeds with a relocation process or job selection process by following procedure proposals displayed on the terminal and marking tasks as completed or skipped.

User input regarding completion status is sent back to the server as updates to procedure progress information.

Input: displayed procedure proposals and checklists on the terminal.

Output: updated completion flags and timestamps per procedure step, transmitted from the terminal to the server.

Terminal maintains a local view of progress and synchronizes with the server to avoid inconsistencies.

### Step 18:

Server updates procedure progress information in the dedicated data storage device using the received completion status.

Server constructs a new prompt sentence for the generative AI model that includes the current procedure progress information and the active job candidate information, requesting an updated list of necessary procedures:
“For the following user, given the current progress of relocation and job selection and the following job candidates, generate an updated list of necessary procedures, including remaining administrative steps, required documents, and recommended execution timing.”

Input: procedure progress information and job candidate information.

Output: a new prompt sentence requesting updated necessary procedures. Server logs the updated prompt sentence and context to refine future procedure-related prompts.

### Step 19:

Server sends the new prompt sentence and associated context to the generative AI model and receives generated text describing necessary procedures.

Server parses the generated procedure descriptions into structured tasks with attributes such as type, priority, prerequisites, and suggested deadlines.

Input: prompt sentence for necessary procedures and current context (progress and job candidates).

Output: a structured list of necessary procedures, each with associated metadata.

Server updates a graph representation of procedures, calculating dependencies and priority scores to optimize the ordering and grouping of tasks.

### Step 20:

Server transmits the structured list of necessary procedures and associated priorities to the terminal.

Terminal displays the procedures as an interactive checklist or timeline, enabling the user to understand remaining steps and their recommended order.

Input: structured procedure list with priorities from the server.

Output: a visual representation of necessary procedures and progress indicators on the terminal display.

User can then continue interacting with the system, repeating previous steps as needed, while the server continually refines prompt sentences, recommendations, and procedure proposals based on new data and emotional state estimates.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional computer-implemented document generation systems, including systems for generating curriculum vitae or similar professional documents, typically require a user to manually structure input data and manually adjust the output document format. In many existing implementations, a server merely receives free-form text, forwards it directly to a generative AI model, and returns the raw output text to a terminal without performing meaningful, machine-level structuring or post-processing. Such architectures impose a substantial cognitive and operational burden on the user, who must understand how to formulate effective prompts, how to supply structured information, and how to revise or reformat the resulting document. As a consequence, the overall system performance in terms of automation, consistency, and reliability is limited, and the underlying computer resources are not utilized in a technically efficient manner.

Furthermore, when personal history information is transmitted to and from an external generative AI model, conventional systems often rely on ad hoc security practices that do not systematically integrate encryption mechanisms, secure communication paths, and controlled storage in a secure environment. This can lead to fragmented implementations of data protection, increased complexity of system integration, and potential vulnerability surfaces in the communication pipeline between the terminal, the server, and the external model.

Additionally, known systems that assist in multi-step processes, such as migration-related procedures, generally treat emotional state analysis and procedural guidance as disconnected functions, if they are present at all. They often lack a unified mechanism by which progress information, user emotional state, and document content are jointly processed to dynamically adapt system behavior. As a result, computational resources are not coordinated to optimize both the generation of machine-readable, structured prompts and the generation of responsive guidance information. This leads to inefficient control flows, redundant processing steps, and limited capacity to automatically generate context-appropriate instructions or proposals.

In view of the above, there is a need for an improved computer-implemented system that (i) automatically converts user-provided personal history information into structured information on the server side, (ii) programmatically constructs and transmits optimized prompt sentences to a generative AI model, (iii) performs systematic post-processing of the generated curriculum vitae draft into standardized data formats suitable for display and printing, (iv) securely manages data transmission and storage through integrated encryption and secure communication paths, and (v) coordinates emotional state recognition with progress tracking to automatically generate and adapt guidance information for complex procedures such as migration. Such a system should improve the functioning of the server and associated components by reducing manual intervention, standardizing data handling, and enabling a more efficient and secure interaction between the server and the generative AI model.

The specific processing by the specific processing unit 290 of the data processing device 12 in Example 2 is realized by the following means.

The present invention provides a server comprising a processor configured to acquire personal history information from a terminal, generate structured information based on the personal history information, and store the structured information in a data storage apparatus in a secure environment; construct, based on the structured information, a prompt sentence in a natural language that instructs generation of a curriculum vitae, transmit the prompt sentence to a generative AI model including a language processing mechanism to cause the generative AI model to generate a draft of the curriculum vitae, and receive the draft of the curriculum vitae from the generative AI model; perform, on the draft of the curriculum vitae, chronological reordering of work history, classification of skill information, and formatting into a predetermined document structure, convert the formatted curriculum vitae into a display data format or a print data format, and provide the converted curriculum vitae to the terminal; control a communication control mechanism in the terminal and in the server so as to encrypt, by using an encryption processing mechanism, the personal history information and the prompt sentence when transmitting the personal history information and the prompt sentence to the data storage apparatus in the secure environment or to the language processing mechanism included in the generative AI model, and to transmit the encrypted information through a secure communication path; store progress information relating to migration procedures of a user in the data storage apparatus, generate, based on the progress information and information relating to the curriculum vitae, a prompt sentence including content for automatically proposing required administrative procedures or life-related procedures, and transmit the prompt sentence to the language processing mechanism included in the generative AI model to cause the generative AI model to generate guidance information for comprehensively supporting a migration process; and recognize an emotional state of the user and adjust a process relating to generation of the curriculum vitae and guidance of migration-related procedures in accordance with the emotional state. This enables an improvement in computer technology by providing a server-centric architecture that automatically structures user input, programmatically constructs and post-processes prompt-based outputs from a generative AI model, integrates secure transmission and storage mechanisms at the protocol and processing levels, and dynamically coordinates emotional state recognition with progress-aware guidance generation, thereby enhancing the efficiency, reliability, and security of document generation and procedural support operations executed by the computing system.

The term “personal history information” refers to information relating to a person's background, including at least employment history, job titles, employment periods, skills, and job descriptions, which is supplied by a user through a terminal for use in generating a curriculum vitae or a related document.

The term “structured information” refers to data that has been converted from free-form or semi-structured input into a machine-readable format organized according to a predefined schema, such as key-value pairs, records, or fields, suitable for programmatic processing by a server.

The term “terminal” refers to an information processing device, such as a client computer, mobile device, or similar user interface device, that enables a user to input personal history information, send the information to a server, and receive and display output data including a generated curriculum vitae.

The term “data storage apparatus” refers to a hardware and software combination, such as a storage server, database system, or cloud-based storage resource, configured to store structured information, progress information, and other data in a persistent or semi-persistent manner.

The term “secure environment” refers to a logical or physical computing environment that applies access control, encryption, and other security mechanisms to protect stored or processed data from unauthorized access, modification, or disclosure.

The term “prompt sentence” refers to a natural language instruction or set of instructions constructed by a processor, which describes an intended output and contextual information, and which is transmitted to a generative AI model to cause the generative AI model to generate a corresponding output such as a curriculum vitae draft or guidance information.

The term “generative AI model” refers to a machine learning model configured to generate text or other content in response to input data including a prompt sentence, and typically implemented as a large-scale neural network capable of natural language processing.

The term “language processing mechanism” refers to a functional component of the generative AI model that performs operations such as tokenization, context analysis, and text generation in order to interpret a prompt sentence and generate output text.

The term “draft of the curriculum vitae” refers to a preliminary version of a curriculum vitae generated by the generative AI model in response to a prompt sentence, prior to post-processing, reformatting, or final approval by a user.

The term “chronological reordering of work history” refers to a processing operation in which work experience entries contained in a curriculum vitae draft are ordered or reordered according to temporal information such as start dates and end dates.

The term “classification of skill information” refers to a processing operation in which individual skills contained in a curriculum vitae draft are grouped or labeled into categories, such as programming languages, tools, or methodologies, in accordance with predefined classification rules.

The term “predetermined document structure” refers to a predefined arrangement of document components, such as sections and subsections, that specifies an order or hierarchy for elements like a summary section, work experience section, and skills section in a generated curriculum vitae.

The term “display data format” refers to a data format suitable for rendering by a user interface on a terminal, such as an HTML document or other format interpretable by a web browser or application for visual presentation.

The term “print data format” refers to a data format suitable for high-quality printing or archiving, such as a page description format or a portable document format, which preserves layout and styling of the generated curriculum vitae.

The term “communication control mechanism” refers to hardware, software, or a combination thereof, that manages the sending and receiving of data between the terminal, the server, the data storage apparatus, and the generative AI model, including protocol handling and connection management.

The term “encryption processing mechanism” refers to a function, module, or subsystem configured to convert plaintext information into encrypted information using a cryptographic algorithm and, optionally, corresponding key management, to protect the information during storage or transmission.

The term “secure communication path” refers to a communication channel that applies security protocols, such as transport layer encryption and integrity protection, to mitigate risks of eavesdropping, tampering, or unauthorized access while data is transmitted between system components.

The term “progress information” refers to information indicating a state or stage of advancement of a multi-step process, such as migration-related procedures, including which steps have been completed, which steps are pending, and associated deadlines or requirements.

The term “migration procedures” refers to a series of administrative or practical steps involved in relocating to a different jurisdiction or region, including, for example, application for permits, registration with authorities, and arrangement of life-related services.

The term “guidance information” refers to content generated for assisting a user in performing tasks or procedures, including recommendations, step-by-step instructions, or proposals for actions, which is produced by the generative AI model in response to a prompt sentence.

The term “emotional state of the user” refers to a state indicative of the user's affect or mood, such as stress, anxiety, or confidence, as inferred from input signals including textual expressions, interaction patterns, or sensor outputs, and used by the system to adapt processing behavior.

In one embodiment, a server cooperates with multiple terminals operated by users to generate and provide curriculum vitae documents and migration guidance information using a generative AI model based on structured personal history information. The server includes at least one processor, a memory, a network interface, and access to a data storage apparatus in a secure environment. The terminal includes at least one processor, a memory, a display device, an input device, and a network interface. The server and the terminals are interconnected via one or more communication networks, such as the Internet, using secure transport protocols.

The terminal executes a client application, for example a web browser application or a native mobile application. The terminal uses a browser engine, such as an HTML/CSS/JavaScript rendering engine, running on an operating system such as a general-purpose operating system, to present a dedicated user interface for curriculum vitae creation and migration assistance. The terminal presents input fields for personal history information, including at least employer name, employment period, job title, responsibilities, and skills. The terminal structures this input internally into a data object and transmits the data to the server over a secure communication path, such as an HTTPS connection using Transport Layer Security.

The server executes a server-side application, for example on an application framework such as a web application framework. The server uses a networking stack to receive incoming requests from the terminals. The server stores configuration data, model access credentials, and structured user data in the data storage apparatus, which may be implemented using a relational database system or a key-value store running in a protected network segment. The data storage apparatus operates in a secure environment with access control, encrypted storage, and network isolation.

The server converts the terminal-provided personal history information into structured information using predefined schemas. The server uses parsing modules to normalize dates into a canonical format, such as converting “2015-2020” into a machine-readable start date and end date representation. The server maps free-form skills into standardized skill identifiers or categories maintained in a server-side taxonomy. The server stores this structured information in tables or collections with explicit fields for employer, position, period, skills, and responsibilities. By normalizing all data into a structured format, the server reduces ambiguity and enables deterministic construction of prompt sentences for the generative AI model.

The server constructs a prompt sentence in a natural language based on the structured information. The server uses a template-based generation module that selects phrase templates and inserts normalized values into specific slots. The prompt sentence includes explicit instructions for the generative AI model to produce a curriculum vitae in a preset structure. An example of such a prompt sentence is:
“Please create a professional curriculum vitae in English based on the following information. Employment history: company—ABC Corporation, period—2015 to 2020, job title Software Engineer. Job description: Developed backend APIs and maintained cloud infrastructure. Skills: Python, JavaScript, Docker, AWS. Organize the output into sections: Summary, Work Experience, Skills, and Education. If education is not specified, add a generic placeholder education section. Use clear headings and bullet points suitable for a technical position.”

In another example, the server constructs a different prompt sentence to obtain migration-related guidance:

“Act as a relocation advisor. Based on the following user status and curriculum vitae information, propose the next required administrative procedures and life-related procedures for relocation. Progress status: residence permit application submitted, address registration not completed, health insurance registration pending. Employment profile: software engineer with 5 years of experience. Provide step-by-step guidance and clearly numbered actions.” The server uses these prompt sentences to control the behavior of the generative AI model in a non-generic manner. The server does not rely on the user to compose the prompts; instead, the server programmatically generates the prompt sentences according to structured rules, resulting in more consistent and machine-optimized interactions with the generative AI model. This server-side generation reduces variance and improves both the speed and accuracy of the text generation process compared to manual prompting performed by non-expert users.

The server communicates with the generative AI model through an application programming interface provided by a model hosting environment. The generative AI model is implemented as a neural network with a transformer architecture. The generative AI model includes a stack of multiple attention layers, each layer including multi-head self-attention sublayers and feed-forward sublayers with non-linear activation functions. The server transmits the prompt sentence as a sequence of tokens, where each token corresponds to a subword unit or character embedding. The generative AI model performs self-attention computations to compute context-aware representations of the input tokens, then successively predicts output tokens representing the draft of the curriculum vitae or guidance information.

The server uses a configuration for the generative AI model including parameters such as maximum output length, sampling temperature, and top-k or top-p sampling thresholds. These parameters control the diversity and determinism of the generated output. The server selects these parameters based on system requirements, for example using a lower temperature to ensure consistent formatting or a higher temperature to encourage variation in descriptive text. The generative AI model is trained on large-scale corpora prior to deployment, using supervised learning and possibly reinforcement learning from human feedback. The training process includes forward passes and backward passes on batches of text sequences, computation of a loss function such as cross-entropy between predicted token probabilities and ground truth tokens, gradient calculation through backpropagation, and iterative weight updates using optimization algorithms such as stochastic gradient descent variants. The training may include regularization techniques and data augmentation, such as masking or shuffling, to improve generalization.

The server does not re-train the generative AI model for each user; instead, the server leverages the pre-trained model and uses prompt engineering and structured pre-processing to adapt the model's generic knowledge to the user's specific context. This separation of concerns enables the server to focus on deterministic data transformations, while the generative AI model focuses on complex natural language modeling. The combined system produces outputs that would be difficult to obtain purely by rule-based text generation or by manual authoring, particularly in terms of speed and stylistic consistency.

The server receives the draft of the curriculum vitae or guidance output from the generative AI model as a sequence of tokens or as text. The server parses the received text and applies post-processing algorithms. For example, the server scans for section headings such as “Summary,” “Work Experience,” “Professional Experience,” “Technical Skills,” and “Education.” The server uses pattern matching and regular expressions to identify boundaries of sections. The server further parses each section into ordered lists of entries. For the work experience section, the server attempts to identify individual positions by detecting date patterns and employer names and then reorders these entries chronologically according to the normalized start and end dates stored in the structured information. This chronological reordering improves the clarity of the document and ensures a predictable structure regardless of the order produced by the generative AI model.

The server also classifies skill information by mapping extracted skills to categories defined in a server-side skills ontology. The server uses string similarity metrics, exact matches, and synonym tables to align model-generated skill names with canonical skill identifiers. The server groups these skills into higher-level categories such as programming languages, frameworks, platforms, tools, and methodologies. By enforcing this categorization, the server reduces redundancy and enhances the readability of the curriculum vitae. The server implements these algorithms in code modules that operate on the textual output and the structured data. These operations are not simple pass-through processes; instead, they impose a deterministic and standardized structure that improves the technical quality of the output.

The server converts the post-processed curriculum vitae into formats suitable for display and printing. The server uses templating engines and formatting libraries to generate display data formats such as markup representations, and uses conversion engines such as document layout libraries or headless rendering engines to generate print data formats such as page description documents. The server applies style rules, such as font selection, spacing, and layout grids, according to preconfigured templates. Because the post-processing has already standardized the structure, the formatting operation is simplified and can be optimized, for example by caching layout calculations for repeated use across multiple users'curriculum vitae.

The terminal receives the formatted curriculum vitae and renders it for the user. The terminal's rendering engine interprets the display data format and displays the formatted curriculum vitae on the display device. The terminal also offers the user an option to download or print the curriculum vitae. When the user selects a print option, the terminal may either use a locally cached print data format or request the server to regenerate the print data format if the user has made edits.

The server implements encryption and secure transmission for personal history information, prompt sentences, and generated outputs. The server controls the communication control mechanism to apply encryption processing using cryptographic libraries implementing algorithms such as AES for symmetric encryption and TLS for transport security. The server uses key management practices, such as retrieval of keys from dedicated secure storage, and applies protocol-level security to prevent unauthorized interception or tampering with user data. By integrating these mechanisms at the server level, the system improves the technical robustness of data protection beyond ad hoc encryption practices applied only at the terminal.

The server additionally manages progress information related to migration procedures. The server maintains a data structure representing milestones, such as completion of documentation, submission of applications, and registration with relevant institutions. The server updates this progress information when the user or external systems report changes. The server then generates specialized prompt sentences that describe the user's current progress and ask the generative AI model to propose next steps. The generative AI model receives a prompt sentence that includes a structured enumeration of completed and pending tasks, which allows the model's language processing mechanism to generate step-by-step guidance aligned with the user's actual status. This approach minimizes unnecessary information and reduces processing overhead by focusing the generative AI model on a constrained, structured context.

The server optionally incorporates a module for recognizing an emotional state of the user.

The terminal may collect textual feedback, response times, or interaction patterns, and the server uses these as input features to an emotion classifier. The emotion classifier may be implemented as a smaller neural network trained on labeled interaction data, using, for example, a recurrent or transformer-based architecture adapted for sentiment analysis. The classifier outputs a representation of the emotional state, such as a probability distribution over emotional categories. The server uses this representation to adjust parameters for prompt construction, such as tone descriptors or level of detail. For instance, when the emotional state indicates high stress, the server may add clarifications or reassurance phrases in the prompt sentence for migration guidance, resulting in more supportive model outputs. The server's overall processing pipeline improves computer technology in several ways.

First, by introducing a structured intermediate representation of personal history information and progress information, the server reduces the entropy of the input to the generative AI model. This leads to faster generation and decreased variability of results, which in turn reduces the need for repeated model calls and lowers computational and communication load.

Second, by implementing deterministic post-processing for chronological reordering and skill classification, the server offloads structure enforcement from the generative model and ensures consistent output layouts, reducing user corrections and round-trip interactions.

Third, by integrating encryption at both the communication and storage layers and controlling this via a central processor, the system improves security without requiring multiple independent implementations on each terminal. Fourth, by using an emotion classifier and progress-aware prompt construction, the server tailors generative AI behavior to user context, improving the efficiency and relevance of the generated guidance information, and avoiding unnecessary network and compute operations.

In another embodiment, the server may use different model architectures, such as encoder-decoder transformer models, recurrent neural networks, or hybrid architectures combining rule-based modules with neural text generation. The server may also adapt the internal schemas of structured information, for example adding fields for certifications, languages, or project summaries, and adjust the prompt templates accordingly. The same structural principles apply: the server normalizes user input into well-defined data structures, constructs machine-optimized prompt sentences, interacts with a generative AI model under controlled parameters, and post-processes the output into standardized formats.

In yet another embodiment, the server may host a local generative AI model instance instead of relying on an external model service. In this case, the server includes additional hardware resources such as graphical processing units or tensor processing units for accelerating matrix multiplications required by the transformer architecture. The server loads model parameters into memory and executes inference locally, using optimized libraries. This configuration increases control over latency, data residency, and resource allocation, and further underscores the technical nature of the invention as an improvement to computing infrastructure.

The terminal may vary according to device type. In one configuration, the terminal is a desktop computer running a browser-based interface. In another configuration, the terminal is a mobile device executing a native application, where the terminal performs preliminary validation and basic formatting before sending structured data to the server. Regardless of the terminal type, the core processing—namely, structured data management, prompt construction, model interaction, and post-processing—occurs on the server, ensuring a consistent architecture and technical behavior across different client platforms.

Through these embodiments, the server, the terminal, and the generative AI model cooperate according to specific data structures, prompt sentence templates, neural network configurations, and post-processing algorithms to provide curriculum vitae generation and migration guidance that extend beyond mere automation of human drafting tasks. The system modifies and constrains the behavior of the underlying computing components in a structured way that yields measurable improvements in processing efficiency, output consistency, security, and context adaptation.

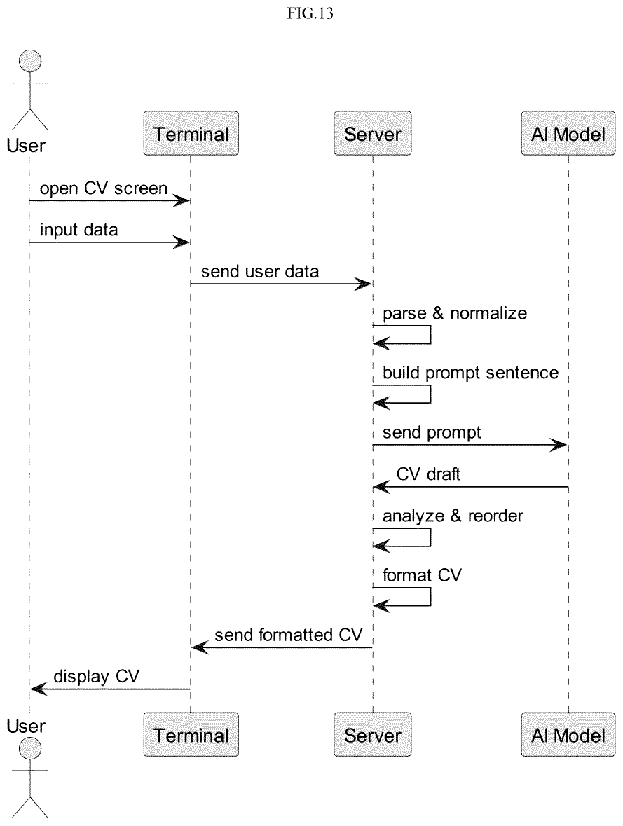

The following describes the processing flow using FIG. 13.

### Step 1:

User operates the terminal to open a dedicated curriculum vitae creation screen. Terminal displays input fields for personal history information, including company name, employment period, job title, responsibilities, and skills. The input of this step is raw keystrokes and selection events produced by the user, and the output is a set of field values stored in the terminal's memory. Terminal performs client-side validation, such as checking that mandatory fields are not empty and that date fields match a prescribed format. Terminal aggregates the validated field values into an internal data object representing the personal history information.

### Step 2:

Terminal converts the internal data object into a structured payload suitable for transmission to the server. The input of this step is the set of field values collected in Step 1, and the output is a structured data representation containing normalized keys and values. Terminal may standardize date formats, split comma-separated skills into a list, and trim extraneous whitespace from text fields. Terminal then establishes a secure communication channel using a transport security protocol and transmits the structured payload to the server via an application programming interface endpoint.

### Step 3:

Server receives the structured payload from the terminal through its network interface. The input of this step is the structured payload transmitted in Step 2, and the output is a set of internal records representing the user's personal history information in server memory. Server invokes a parsing module to decode the payload and map incoming fields to predefined schema elements such as employer, role, start date, end date, and skills. Server writes these mapped values into a structured information store, for example as entries in relational database tables or as documents in a data storage apparatus. Server performs normalization operations, including converting employment periods into separate start and end timestamps and mapping raw skill strings to canonical skill identifiers.

### Step 4:

Server generates structured information tailored for prompt construction. The input of this step is the normalized records stored in the data storage apparatus, and the output is a composite structured object suitable for insertion into a prompt sentence template. Server queries the data storage apparatus to retrieve all relevant records for a given user, orders employment entries by start date using comparison operations on timestamps, and groups skills into high-level categories according to a predefined taxonomy. Server computes derived attributes, such as total years of experience, by subtracting start dates from end dates and summing intervals. Server assembles these attributes into a structured representation that captures the essential facts for curriculum vitae generation.

### Step 5:

Server constructs a prompt sentence in natural language based on the composite structured object. The input of this step is the structured representation produced in Step 4, and the output is a text string representing the prompt sentence. Server selects an appropriate template according to configuration parameters, such as language and document style, and inserts normalized values into designated slots. For example, server may generate the following prompt sentence:
“Please create a professional curriculum vitae in English based on the following information. Employment history: company—ABC Corporation, period—2015 to 2020, job title Software Engineer. Job description: Developed backend APIs and maintained cloud infrastructure. Skills: Python, JavaScript, Docker, AWS. Organize the output into sections: Summary, Work Experience, Skills, and Education. If education is not specified, add a generic placeholder education section. Use clear headings and bullet points suitable for a technical position.”

Server stores the resulting prompt sentence as a string in working memory and logs a sanitized version for monitoring.

### Step 6:

Server prepares and sends a request to the generative AI model containing the prompt sentence. The input of this step is the prompt sentence produced in Step 5, and the output is a formatted request message transmitted to the generative AI model's interface. Server encapsulates the prompt sentence in a request body that conforms to the generative AI model's application programming interface specification and attaches configuration parameters such as maximum token length and temperature. Server applies an encryption processing mechanism at the transport layer to secure the communication and then transmits the request to the generative AI model endpoint over a secure communication path.

### Step 7:

Generative AI model processes the prompt sentence using a neural network with a transformer architecture. The input of this step is the tokenized representation of the prompt sentence received from the server, and the output is a sequence of generated tokens corresponding to a draft of the curriculum vitae. The model converts the input text into embeddings, applies multi-head self-attention and feed-forward layers to compute contextual representations, and iteratively predicts next tokens according to a learned probability distribution. The model constructs the output in the form of structured text with sections and bullet points, then returns this text as a response message to the server.

### Step 8:

Server receives and parses the response from the generative AI model. The input of this step is the response message containing the generated token sequence or text, and the output is an internal representation of the draft of the curriculum vitae. Server extracts the generated text from the response fields and stores it as a string in memory. Server optionally segments the text into lines or paragraphs by splitting at newline characters or other delimiters, producing a list of text segments for further analysis. Server may associate a timestamp and a user identifier with the draft for traceability.

### Step 9:

Server performs structural analysis on the draft of the curriculum vitae. The input of this step is the generated text string or list of text segments from Step 8, and the output is a structured document model with explicit sections and entries. Server scans the text using pattern matching to locate headings such as “Summary,” “Work Experience,” “Professional Experience,” “Technical Skills,” and “Education.” Server uses these headings as markers to partition the text into sections. Within each section, server identifies list items, date expressions, and employer names by applying regular expressions and rule-based parsing. The result is a hierarchical internal structure where each section contains a collection of entries with associated attributes.

### Step 10:

Server reconciles the structural analysis with the original structured information. The input of this step is the hierarchical document model from Step 9 and the original structured personal history information from Step 4, and the output is an adjusted document model with corrected ordering and enriched attributes. Server compares date fields inferred from the generated text with canonical dates stored in the structured information and reorders work experience entries chronologically if necessary. Server aligns generated employer names and roles with normalized values already stored in the database to correct minor textual inconsistencies. Server enriches entries with missing attributes, such as adding start or end dates from the structured records if the generative AI model omitted them.

### Step 11:

Server classifies and organizes skill information within the document model. The input of this step is the skill-related content extracted from the generated text and the canonical skill identifiers associated with the user, and the output is a categorized skills section. Server tokenizes the generated skills text into individual skill names, performs string matching and similarity checks against the canonical skills list, and maps matched skills to predefined categories such as programming languages, frameworks, development tools, and methodologies. Server then constructs a structured skills section in which entries are grouped and ordered according to these categories, replacing or supplementing the skills portion of the generated text as needed.

### Step 12:

Server formats the adjusted document model into a display data format. The input of this step is the fully reconciled and categorized document model from Steps 10 and 11, and the output is a markup representation suitable for rendering by the terminal. Server injects headers, lists, and paragraphs into a template structure and populates placeholder locations with the actual content from the document model. Server applies style attributes, such as heading levels and indentation, and serializes the result as a formatted text document ready for transmission. This formatted representation maintains a consistent layout independent of stylistic variations in the generative AI model output.

### Step 13:

Server optionally converts the display data format into a print data format. The input of this step is the markup representation produced in Step 12, and the output is a binary or stream representation of a paginated document suitable for high-quality printing. Server invokes a document rendering engine to layout text, headings, and lists on pages according to specified margins and typographic settings. Server embeds fonts and images as necessary and generates a final print-ready document. Server may cache this print data format for reuse if the user requests repeated downloads without modifying the underlying document.

### Step 14:

Server transmits the formatted curriculum vitae to the terminal. The input of this step is the display data format and, when requested, the print data format generated in Steps 12 and 13, and the output is one or more response messages sent to the terminal. Server selects appropriate response headers indicating whether the payload is intended for on-screen display or for file download. Server uses the established secure communication path to transfer the formatted data and records the transaction status in internal logs.

### Step 15:

Terminal receives and renders the formatted curriculum vitae for the user. The input of this step is the response message containing the display data format or print data format from Step 14, and the output is a visual presentation on the terminal's display or a file artifact stored on the terminal. Terminal's rendering engine parses the display data format and draws text and structure on the screen for review. When the response contains a print data format, terminal either presents the document in a viewer or triggers the operating system's print or save dialog. User then inspects the curriculum vitae, and, if desired, initiates further actions such as requesting guidance information or making edits, which can trigger another iteration of the processing pipeline.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional computerized support for migration, employment, and residence selection generally relies on separate, siloed applications for document preparation, task management, payment processing, and user-state monitoring. These conventional systems typically require a user to manually reenter similar personal information into multiple tools, to copy and paste content between applications, and to interpret generic system guidance without any adaptation to the user's changing emotional state. As a result, server-side processing pipelines become fragmented, user interfaces remain rigid, and the overall workflow is error-prone and time-consuming.

In existing architectures, a server generally treats user profile data as static input to simple template engines, and does not leverage a generative AI model through explicit prompt sentences to dynamically synthesize work-history information and proposal documents suitable for automated downstream processing. Likewise, conventional systems typically do not integrate an emotion-analysis engine with the core orchestration logic of the server. Emotion signals, if used at all, are processed in a separate analytics module and are not used in real time to adjust scheduling logic, task selection, or electronic document delivery. This separation causes the server to execute a fixed control flow that is insensitive to the user's current cognitive load and stress level, which can degrade the effectiveness and efficiency of the computerized process itself.

Furthermore, traditional systems often lack a unified mechanism by which a server securely acquires personal information from terminals, stores that information in a protected storage area, uses the information to construct precise prompt sentences for a generative AI model, and then feeds the generated outputs back into an automated, state-dependent control loop. Without such a mechanism, the server cannot consistently generate machine-understandable work-history data and proposal-document data, cannot automatically issue electronic document data via electronic payment services, and cannot adapt task-presentation and scheduling to improve the underlying computer-implemented workflow. This leads to increased server load due to redundant processing, complex client-side logic, and non-optimized database access patterns.

Accordingly, there is a need for an improved computer-implemented technique in which a server, using a processor, (i) securely receives and stores personal information, (ii) constructs and transmits prompt sentences to a generative AI model to obtain work-history information and proposal-document information in a form directly usable by backend processes, (iii) generates and delivers electronic document data via an external electronic payment service, and (iv) performs emotion analysis on user text or voice data to dynamically adjust progression conditions, task-presentation contents, and schedules of a migration or employment-and-residence decision-making process. By tightly integrating these steps in a single, orchestrated server-side workflow, the invention aims to improve the operation of the computer system itself, including more efficient use of processing resources, reduced user interaction steps, and more adaptive control of automated procedures.

The specific processing by the specific processing unit 290 of the data processing device 12 in Application Example 2 is realized by the following means.

The present invention provides a server comprising a processor configured to receive, from a terminal, personal information and store the personal information in a protected storage area; to construct, on the basis of the personal information, a prompt sentence for generating work-history information and proposal-document information, to transmit the prompt sentence to a generative AI model, and to acquire natural-language text representing the work-history information and the proposal-document information from the generative AI model; to generate electronic document data based on the proposal-document information and to transmit the electronic document data to an external device via an electronic payment service; to perform emotion-analysis processing on text data or voice data acquired from a user so as to identify an emotional state of the user; to dynamically adjust at least one of progression conditions, task-presentation contents, and schedules of a migration process or an employment-and-residence decision-making process, based on the emotional state and at least a part of one or more of the work-history information, the proposal-document information, and the electronic document data; and to generate output data for presenting the work-history information, the proposal-document information, the electronic document data, and information relating to the adjusted process to the terminal. This enables the computer system to operate in a technically improved manner by unifying secure data acquisition, AI-based content generation, emotion-aware control logic, and automated electronic document delivery in a single server-side workflow, thereby reducing redundant user input, optimizing server processing paths, and adaptively controlling task execution and scheduling according to real-time user state.

The term “processor” refers to a hardware circuitry or a combination of hardware circuitry and machine-executable instructions that performs arithmetic, logic, control, and data-processing operations to execute the functions described in the present specification.

The term “terminal” refers to an information-processing apparatus operated by a user, such as a general-purpose computing device or a portable communication device, that transmits data to and receives data from the server over a communication network.

The term “personal information” refers to information related to an individual user, including at least work history data, skill data, identification data, preference data, and other profile data used for document generation and process control.

The term “protected storage area” refers to a logical or physical storage region, such as a memory device or external storage system, in which data is stored with access control, encryption, or other security measures to prevent unauthorized access or modification.

The term “prompt sentence” refers to a text string or structured textual instruction generated by the processor and supplied to a generative AI model to specify a task and context for generating natural-language output.

The term “generative AI model” refers to a trained machine-learning model that receives a prompt sentence as input and outputs generated natural-language text or other content according to learned statistical patterns.

The term “work-history information” refers to structured or unstructured data representing the employment background of a user, including previous positions, durations, responsibilities, and achievements, as generated or organized by the processor and/or the generative AI model.

The term “proposal-document information” refers to structured or unstructured data representing a proposal, offer, or plan related to a project, employment, or service, generated based on the personal information and output from the generative AI model.

The term “natural-language text” refers to text expressed using a human language, such as sentences and paragraphs, that can be read and understood by a human without requiring machine-specific formatting.

The term “electronic document data” refers to digital data representing a document, including but not limited to formatted text data, markup data, or file data such as a portable document format file, generated for transmission or storage by the processor.

The term “electronic payment service” refers to a network-accessible payment platform or settlement system that processes monetary transactions electronically and that can be invoked by the processor via an interface or application programming interface.

The term “external device” refers to any device, system, or service separate from the server, such as a client system of a transaction counterparty, an information-processing apparatus, or a network service, that receives electronic document data or related information from the server.

The term “emotion-analysis processing” refers to a computation performed on user text data, voice data, or derived features to estimate an emotional state, using rule-based methods, statistical methods, or machine-learning models.

The term “emotional state” refers to a state indicating a psychological or affective condition of a user, such as stress, anxiety, calmness, joy, or confidence, inferred by the processor through emotion-analysis processing.

The term “migration process” refers to a sequence of computer-assisted steps or procedures related to relocation of a user, including at least job search, visa or permit preparation, and residence selection.

The term “employment-and-residence decision-making process” refers to a computer-assisted workflow in which the user selects employment options, residence options, or related service options, based on information and proposals generated by the server.

The term “progression conditions” refers to parameters or criteria used by the processor to determine whether and how a particular step or task in a process should be initiated, continued, postponed, or completed.

The term “task-presentation contents” refers to information items, such as task descriptions, instructions, or recommended actions, that are generated and output by the processor for display to the user on the terminal as part of a workflow.

The term “schedule” refers to time-related control information, including execution times, deadlines, reminders, and ordering of tasks or events, used by the processor to manage the timing of process steps.

The term “output data” refers to data generated by the processor for transmission to the terminal, including at least work-history information, proposal-document information, electronic document data, process-control information, and any associated visual or textual representations.

The term “secure communication channel” refers to a communication path between the server and the terminal that employs at least encryption and integrity protection to prevent unauthorized interception or tampering of transmitted data.

The term “data-encryption technique” refers to a cryptographic method or algorithm used by the processor to transform plaintext data into ciphertext so that the data is protected against unauthorized access or disclosure.

The term “progress information of the user” refers to data indicating a current state, completion status, or history of tasks or steps performed by the user within the migration process or the employment-and-residence decision-making process.

The term “management information” refers to control information regarding tasks, including at least priorities, execution order, execution timing, and dependencies, used by the processor and optionally encoded within a prompt sentence.

The term “proposal contents” refers to the substantive contents of recommended tasks, procedures, or options generated by the generative AI model, based on management information and other context supplied by the processor.

The term “explanatory text” refers to natural-language text generated for explaining the meaning, purpose, or steps of tasks or procedures proposed to the user.

The term “automatic proposal” refers to a behavior of the system in which the processor, based on outputs from the generative AI model and internal control logic, presents recommended tasks or procedures to the user without requiring the user to manually define each recommendation.

In one embodiment, a server includes a processor, a memory, a network interface, and a persistent storage device. The server is connected via a communication network to at least one terminal operated by a user. The terminal is implemented as a general-purpose computing device such as a portable information device, a desktop computer, or a wearable display device. The terminal executes a client application or web browser and provides an input and display interface for the user.

The server stores in the memory a set of software modules including an application server framework, a database management system, a generative AI interface module, an emotion-analysis interface module, a workflow-control module, and a document-generation module. The server uses an application server framework such as a general web framework (for example, a framework of a type similar to Flask) to provide network endpoints, and uses a relational database system such as a general relational database engine (for example, a system of a type similar to MySQL or PostgreSQL) to persistently store data. The server further stores pre-configured parameters and model identifiers to interact with an external generative AI model and external emotion-analysis services.

The terminal acquires personal information from the user, such as work history, skill information, desired job category, desired living area, and free-text comments. The terminal presents input forms and text areas and acquires text data and, in some embodiments, audio data via a microphone. The terminal aggregates the acquired data into structured records and transmits the data to the server via a secure communication protocol such as a protocol of a type similar to HTTPS.

The server receives the personal information via the network interface and stores the information in a protected storage area. The server applies a data-encryption technique, for example, a symmetric-key cipher of a type similar to an AES-based method, to encrypt the personal information before storage. The server stores the encrypted data in a protected data storage structure such as an encrypted table in a relational database or an encrypted object in an external storage service of a type similar to a secure object store. The server maintains an index structure, such as a key-value mapping from user identifiers to encrypted records, to permit efficient retrieval of personal information.

The server converts the stored personal information into an internal structured representation. The server uses text-processing libraries (for example, a library of a type similar to spaCy or NLTK) to perform tokenization, part-of-speech tagging, and entity extraction. The server identifies entities such as position titles, organization types, skill names, periods of employment, and performance metrics. The server then maps the extracted entities into a normalized work-history schema, including fields such as job_title, start_date, end_date, skill_list, and achievement_score. The server stores this normalized data in separate normalized tables in the relational database to reduce redundancy and enable indexed queries.

The server constructs a prompt sentence for a generative AI model using the normalized data.

The server assembles the work-history information, skill lists, and context parameters into a controlled text template that constrains the generative AI model's output. For example, the server constructs a prompt sentence such as:
“Generate a professional résumé using the following information.
Work experience: software development engineer, 5 years, responsible for backend systems and performance optimization.
Skills: programming, data processing, distributed systems.
Education: bachelor's degree in computer science.

Output the résumé in formal business English, with clear sections for summary, experience, skills, and education.”

The server also constructs another prompt sentence for proposal-document information, for example:
“You are a proposal writer. Based on the following user profile, generate a detailed project proposal for a web application development project.
Work history: multiple web development projects with responsibility for front-end and back-end design.
Skills: scripting, reactive front-end framework, server-side programming.
Client: small to medium-sized business seeking an e-commerce platform.

Include sections for objectives, scope, schedule, and cost.”

The server transmits such prompt sentences to a generative AI model hosted on a computing environment. The generative AI model is implemented as a neural network-based language model, for instance a transformer architecture with multiple attention layers, a word-piece or subword tokenizer, and a large number of trainable parameters. During training, the neural network uses a loss function such as a cross-entropy loss between predicted token distributions and ground-truth tokens, and a gradient-based optimization algorithm such as an adaptive gradient method. The generative AI model learns contextual dependencies and semantic relationships between tokens, enabling the model to output coherent natural-language text in response to the prompt sentence.

The server, in operation, does not modify the weights of the generative AI model, but uses the model in an inference mode. The server specifies decoding parameters such as a maximum token length, a temperature parameter, and a top-k or nucleus sampling threshold. The server uses constrained prompting by including explicit section headers and formatting directives in the prompt sentence to induce outputs that can be parsed by the server. For example, the server may require that each work-experience entry is prefixed with a label, which allows deterministic parsing.

The server receives the output text from the generative AI model and performs post-processing. The server splits the text into sections, validates that each section contains required elements, and converts the text into a structured form aligned with internal schemas.

This structured form is used both for human presentation and for machine processing. By enforcing such structured prompt design and post-processing, the server reduces the need for manual editing, improves consistency, and makes downstream processing more efficient. The server generates electronic document data based on the proposal-document information.

The server converts formatted text into a typeset document using a document layout engine such as a generator of a type similar to a PDF generation library. The server embeds metadata such as a user identifier, a timestamp, and a hash of the document content to support integrity checking. The server stores the generated electronic document in the protected storage area, and maintains a mapping from proposal identifiers to document locations.

The server interacts with an external electronic payment service using an application programming interface. The server registers a transaction record containing a link to the generated electronic document data, along with payment amount and counterpart information.

The server transmits the document data or a public link to the external device that represents a client system of the counterpart. By performing such interaction at the server side, using structured records and secure identifiers, the system improves reliability and traceability of electronic document delivery.

The server further performs emotion-analysis processing on text data or voice data acquired from the user. The terminal acquires user-generated text, such as free-form comments, and optionally voice input that is converted into text by a speech-recognition service. The server then applies an emotion-analysis module. In one variant, the server uses an external emotion-analysis service that implements a neural network-based classifier. In another variant, the server implements an internal classifier model, in which text is encoded into feature vectors using a pre-trained language encoder, and a shallow classifier layer outputs probabilities for discrete emotional states such as “stressed,” “uncertain,” “calm,” or “confident.” The classifier uses a training dataset annotated with emotion labels and a loss function such as categorical cross-entropy, optimized using a gradient-based method.

The server maps the classifier output to an emotional state and records the emotional state along with a timestamp and a context identifier. The server uses this emotional state in combination with the current workflow state to adjust progression conditions, task-presentation contents, and schedules. The workflow-control module in the server represents each process—such as migration, employment, residence search, and payment plan selection—as a state machine or directed graph of tasks. Each task has associated prerequisites, estimated duration, and priority. The server stores these task definitions in database tables and loads them into memory when managing a user-specific workflow instance.

The server, based on the emotional state, modifies task priorities and time windows in a non-trivial manner. For example, when the user is classified as stressed, the server reduces the number of simultaneously active tasks by lowering the priority of non-critical tasks and increasing deadlines for non-time-sensitive tasks. When the user is classified as confident, the server may raise the priority of more complex tasks and compress schedules to make more efficient use of time. The server avoids a simple linear mapping from emotion to a static message; instead, the server adjusts actual internal scheduling parameters and task selection logic, which in turn modifies how the computer allocates processing resources and communication events.

The server uses the generative AI model not only for document generation but also for automatic generation of explanatory text and task guidance. The server constructs a management prompt sentence that includes management information such as task identifiers, priorities, and estimated durations. For example, the server constructs a prompt sentence such as:
“Based on the following tasks and their priorities and deadlines, generate a concise explanation for the user about which tasks should be completed this week and why.
Task A: prepare résumé, priority high, deadline in 3 days.
Task B: select 3 housing options, priority medium, deadline in 7 days.
Task C: review payment plans, priority low, deadline in 14 days.

The user is currently feeling stressed. Provide supportive language and clear next steps.”

The server sends this prompt sentence to the generative AI model and receives explanatory text. The server then displays this explanatory text on the terminal together with structured task information. In this way, the output of the generative AI model is constrained by explicit management information and is tied directly to internal scheduling and resource allocation logic.

The server, by performing such integrated processing, improves computer-technical aspects, including data management, processing efficiency, and communication load. The normalized schema and encrypted storage reduce duplication and improve database query performance, which results in faster access to user data and generated documents. The use of structured prompt sentences and controlled decoding reduces the need for repeated calls to the generative AI model and thus reduces network load and response latency. The emotion-aware workflow adjustment reduces unnecessary notifications and rescheduling operations, leading to fewer round-trip communications between the terminal and the server.

The server also improves accuracy and robustness compared with conventional systems. The combination of normalized work-history information and constrained prompt design yields generated résumés and proposals that are less prone to inconsistencies and formatting errors. The emotion classifier, by using supervised learning with an explicit loss function, provides a quantifiable measure of emotional state, which leads to more reliable workflow adaptation than manual heuristics. The server's task scheduling logic uses discrete states and numeric thresholds, which allows reproducible behavior and facilitates optimization of processing schedules.

The terminal presents the generated work-history information, proposal-document information, electronic document data, and adjusted process information in a user interface.

The terminal receives structured output data from the server, including text, document links, and task metadata. The terminal renders the information using a graphical user interface toolkit. The terminal may display résumé previews, proposal documents, task lists, and emotion-aware guidance messages. The user can select actions such as approving a résumé, confirming a proposal, or choosing a housing option. The terminal transmits user selections back to the server, which records the selections and updates the workflow state.

In another embodiment, the server interacts with a different type of generative AI model, such as a smaller domain-specific model hosted locally. In this case, the server stores the model parameters in local storage and loads the model into memory at runtime. The server may use a transformer network with fewer layers and a reduced vocabulary, trained on a domain-specific corpus such as employment-related documents. The server executes the model on a hardware accelerator such as a graphics processing unit or a tensor processing unit. This configuration reduces latency and dependence on external services, and provides more direct control over model parameters and update policies.

In a further embodiment, the server modifies the document-generation process to support multiple output formats, such as portable document format, markup languages, or word-processing formats. The server maintains a common intermediate representation, such as a structured tree of sections and paragraphs, and uses format-specific renderers to convert the intermediate representation into each output format. By centralizing the conversion logic in the server, the system avoids duplicative formatting logic on the terminal side and reduces the possibility of inconsistent representations across different devices. In another variation, the server integrates additional sensor input from the terminal, such as interaction patterns (e.g., typing speed, frequency of help requests) or physiological data where available. The server uses these additional features as input to the emotion classifier.

The classifier architecture is extended to accept multi-modal input, for example by concatenating text embeddings with normalized interaction metrics and feeding them into a fully connected layer. This multi-modal approach increases the accuracy of emotion estimation and results in more precise workflow adjustments.

In yet another embodiment, the server maintains historical logs of emotional states, document-generation outcomes, and task completion times. The server periodically analyzes these logs using statistical methods or machine-learning algorithms to tune parameters such as default priorities, prompt templates, and decoding settings. For example, if the server detects that certain prompt templates frequently produce proposals that require manual correction, the server can adjust the templates to include clearer instructions for the generative AI model. If the server identifies that certain emotion-based adjustments consistently lead to faster completion times, the server can reinforce such rules.

By implementing these embodiments, the server, the terminal, and the user cooperate in a computer-implemented environment that goes beyond mere automation of human tasks. The server enforces specific data structures, processing flows, and adaptive control logic that are uniquely suited to machine execution. The generative AI model is used under constrained, structured conditions to produce outputs that feed directly into machine-readable workflows.

The emotion-aware adjustments modify internal scheduling and resource allocation at the server level, yielding technical effects such as improved processing speed, reduced network load, and increased reliability of automated document and workflow generation.

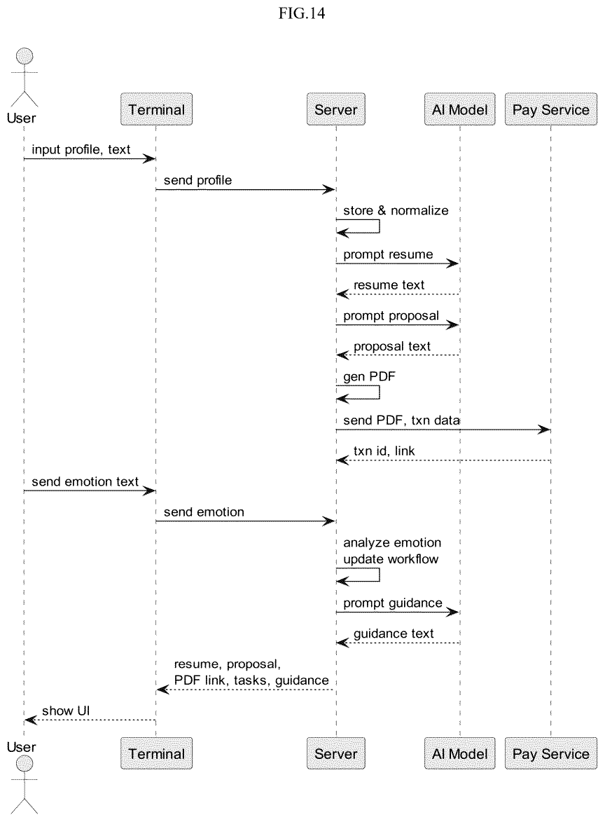

The following describes the processing flow using FIG. 14.

### Step 1:

User operates the terminal to input personal information such as work history, skills, desired job type, desired living area, and free-text comments.

Input: raw text entered into form fields and, optionally, audio captured by a microphone.

Terminal collects these values into a structured record (for example, key-value pairs for each field) and temporarily stores the record in local memory.

Terminal performs basic client-side validation (for example, terminal checks that mandatory fields are not empty and that email-like strings contain an “@” symbol).

Terminal transmits the structured record to the server via a secure communication protocol.

Output: a validated, structured personal-information payload sent over the network to the server.

### Step 2:

Server receives the structured personal-information payload from the terminal via the network interface.

Input: structured record including identification data, free-form work-history text, skills text, and optional audio or audio-derived text.

Server parses the payload into internal data structures and assigns a user identifier if one is not already present.

Server applies a data-encryption technique to the personal information, converting plaintext fields into ciphertext using a symmetric encryption algorithm.

Server stores the encrypted record and associated metadata (for example, timestamps, user identifier) in a protected storage area, such as an encrypted table in a database.

Output: an encrypted personal-information record stored in persistent storage and an internal reference to that record (user ID and record ID).

### Step 3:

Server retrieves the newly stored personal-information record and converts it into a normalized representation suitable for further analysis.

Input: encrypted stored record and associated user identifier.

Server decrypts the record and obtains plaintext work-history text, skills text, and other profile fields.

Server uses text-processing functions to tokenize the text, to detect sentences, and to extract entities such as job titles, organizations, time periods, and technical skills.

Server maps extracted entities to fields of an internal schema (for example, job_title, start_date, end_date, skill_list) and stores these in normalized database tables with indexing for fast lookup.

Output: a normalized work-history dataset and a normalized skill dataset associated with the user.

### Step 4:

Server constructs a first prompt sentence for a generative AI model to generate work-history information in résumé format.

Input: normalized work-history dataset and skill dataset.

Server assembles a text template that includes explicit section labels and instructions for the desired output structure, inserting the user's normalized data into the template.

For example, the server constructs a prompt sentence such as:
“Generate a professional résumé using the following information. Work experience: software development engineer, 5 years, responsible for backend systems and performance optimization.
Skills: programming, data processing, distributed systems.
Education: bachelor's degree in computer science.

Output the résumé in formal business English, with clear sections for summary, experience, skills, and education.”

Server encodes this prompt sentence as part of a request object to the generative AI model.

Output: a fully formed prompt sentence ready for transmission to the generative AI model.

### Step 5:

Server constructs a second prompt sentence for the generative AI model to generate proposal-document information.

Input: the same normalized work-history dataset, skill dataset, and additional context such as a target project type or client category.

Server assembles another text template that describes the desired proposal structure and inserts user-specific context into the template. For example, the server constructs a prompt sentence such as:

“You are a proposal writer. Based on the following user profile, generate a detailed project proposal for a web application development project.

Work history: multiple web development projects with responsibility for front-end and back-end design.

Skills: scripting, reactive front-end framework, server-side programming.

Client: small to medium-sized business seeking an e-commerce platform.

Include sections for objectives, scope, schedule, and cost.”

Server prepares this prompt sentence as a second request object to the generative AI model. Output: a second prompt sentence and a corresponding request object for proposal-document generation.

### Step 6:

Server transmits the prompt sentences to the generative AI model and receives generated natural-language text.

Input: first and second prompt sentences, model name, and inference parameters (for example, maximum output length, temperature, sampling parameters).

Server sends the first prompt sentence to the generative AI model and receives a natural-language résumé text.

Server sends the second prompt sentence to the generative AI model and receives a natural-language proposal-document text.

Server parses the responses, separates sections according to the labels specified in the prompts, and checks that required parts (for example, summary, experience, objectives) are present.

Output: a generated résumé text and a generated proposal-document text, each structured into identifiable sections.

### Step 7:

Server converts the generated proposal-document text into electronic document data suitable for delivery.

Input: generated proposal-document text with delineated sections and formatting cues.

Server processes the text to create a layout structure, including headings, paragraphs, and bullet lists.

Server renders this structure into a document format such as a paginated electronic file by using a document-generation engine.

Server embeds metadata (for example, proposal identifier, user identifier, creation timestamp) into the electronic document.

Server stores the electronic document in the protected storage area and records its storage location and metadata in the database.

Output: an electronic document data object representing the proposal and a stored record linking the document to the user and to a transaction.

### Step 8:

Server interacts with an electronic payment service to transmit the electronic document data to an external device.

Input: stored electronic document metadata, user identifier, and transaction parameters such as amount, currency, and counterpart contact information.

Server constructs a transaction record that includes a link or reference to the stored electronic document.

Server invokes an interface of the electronic payment service, supplying the transaction record and any required authentication credentials.

Server receives a response from the electronic payment service that includes a transaction identifier and, in some implementations, a payment link. Server updates the internal database to associate the transaction identifier with the electronic document and with the user.

Output: a completed or pending transaction record including a reference to the electronic document and a transaction identifier.

### Step 9:

User provides additional text or voice input reflecting current feelings or questions, and the terminal sends this data to the server for emotion analysis.

Input: free-form text typed by the user, or audio captured by the terminal and optionally converted to text by speech recognition.

Terminal packages this new input together with the user identifier and context (for example, which screen the user is viewing) and transmits it to the server.

Output: a user emotion-input payload received by the server for analysis.

### Step 10:

Server performs emotion-analysis processing to identify an emotional state of the user.

Input: user emotion-input payload containing text or text derived from audio, and optionally interaction metrics such as time taken to respond or frequency of help-button usage. Server preprocesses the text (for example, lowercasing, removing punctuation where appropriate, and segmenting sentences), and encodes the text using a language-encoding component to obtain feature vectors.

Server combines the text feature vectors with any interaction metrics into a feature vector input for an emotion classifier.

Server applies a trained classifier model that outputs probabilities for discrete emotions, and selects the emotional state with the highest probability or with probability above a threshold. Server records the emotional state, the probability distribution, and associated context identifiers in the database.

Output: a classified emotional state for the user, associated with a time and context.

### Step 11:

Server adjusts workflow parameters and task management based on the emotional state and on the generated data.

Input: current emotional state, normalized work-history information, generated résumé text, generated proposal-document text, and existing workflow definition for the user.

Server accesses a workflow record consisting of tasks, each with priority, deadline, dependencies, and state.

Server modifies at least one of task priorities, deadlines, and visibility flags according to rules that relate emotional state to workload adjustments.

For example, when the emotional state indicates stress, the server lowers priority of non-urgent tasks and extends their deadlines; when the emotional state indicates confidence, the server raises priority of more complex tasks and brings deadlines forward.

Server updates the workflow record in the database, ensuring that these changes affect subsequent processing and notifications.

Output: an updated workflow record with adjusted progression conditions, task-presentation contents, and schedules.

### Step 12:

Server generates output data for presentation on the terminal, combining document information and adjusted workflow information.

Input: generated résumé text, generated proposal-document text, electronic document metadata, adjusted workflow record, and emotional-state information.

Server assembles a response that includes structured résumé sections, proposal sections, document links, a task list derived from the workflow record, and explanatory text for the user.

Server may use the generative AI model again with a management-oriented prompt sentence to generate explanatory text about which tasks are important and how to proceed, for example:
“Based on the following tasks and their priorities and deadlines, generate a concise explanation for the user about which tasks should be completed this week and why.
Task A: prepare résumé, priority high, deadline in 3 days.
Task B: select 3 housing options, priority medium, deadline in 7 days.
Task C: review payment plans, priority low, deadline in 14 days.

The user is currently feeling stressed. Provide supportive language and clear next steps.”

Server integrates the generated explanatory text into the response.

Output: a comprehensive output payload containing documents, links, tasks, and emotion-aware guidance.

### Step 13:

Terminal receives the output payload from the server and renders it for the user.

Input: structured response containing résumé sections, proposal sections, document links, task metadata, and explanatory text.

Terminal maps each component of the response to user-interface elements such as résumépreview panels, proposal document viewers, task lists with deadlines, and message areas showing guidance.

Terminal updates the display to present the adjusted workflow and generated documents to the user and enables user interactions such as approving documents, following links, and marking tasks as complete.

Output: a rendered user interface that reflects the current state of documents and workflow and that allows the user to perform further actions.

### Step 14:

User reviews the presented information and performs follow-up actions, which the terminal sends back to the server for further processing.

Input: user selections such as confirmation of a résumé, acceptance of a proposal, choice of a housing candidate, or completion of specific tasks.

Terminal translates these user actions into structured events tagged with task identifiers and document identifiers and transmits these events to the server.

Server receives the events, updates document statuses and workflow states accordingly, and, if necessary, triggers additional processing such as generating new prompt sentences for revised documents or recalculating task schedules.

Output: updated server-side records reflecting user decisions, enabling continuous, adaptive operation of the system.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

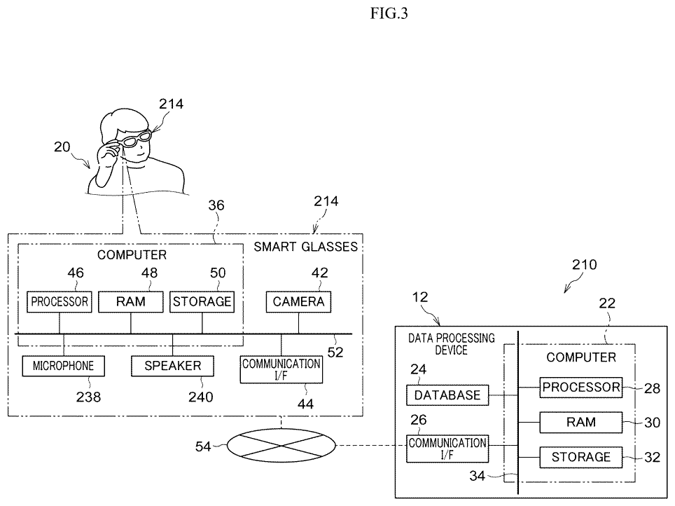

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

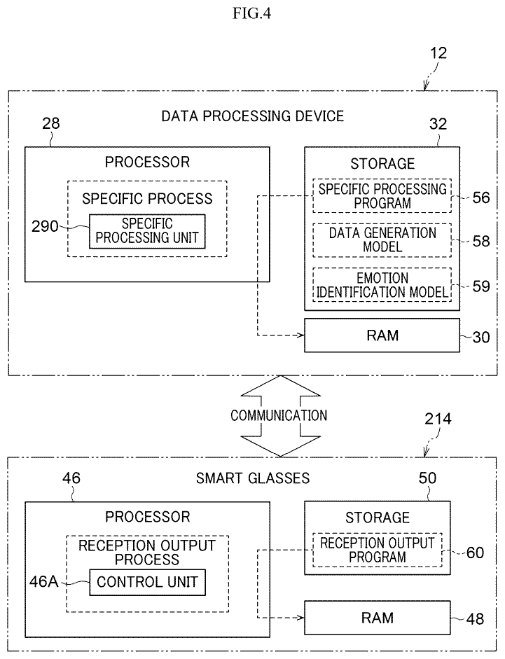

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

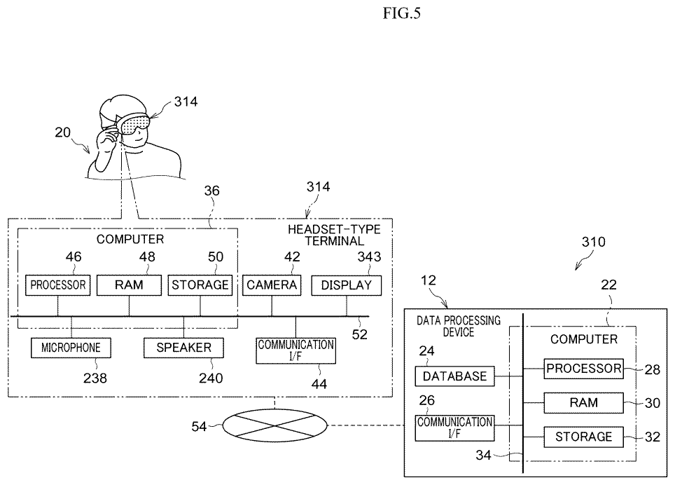

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

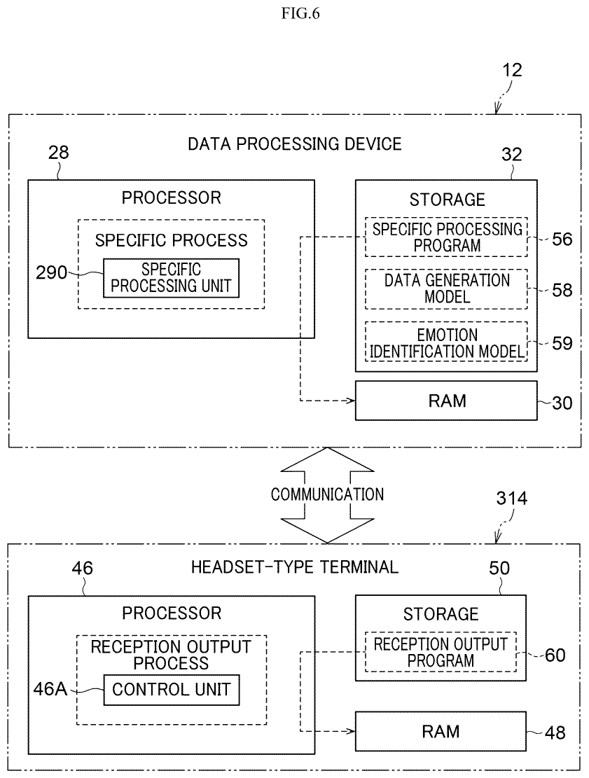

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

Example 2 Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

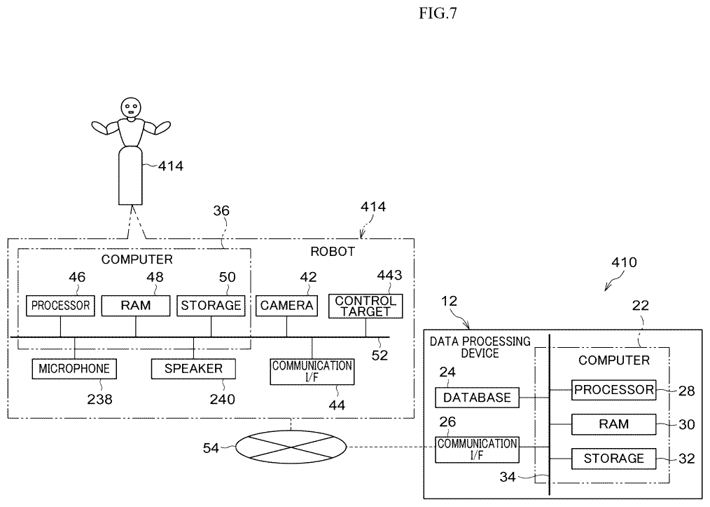

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

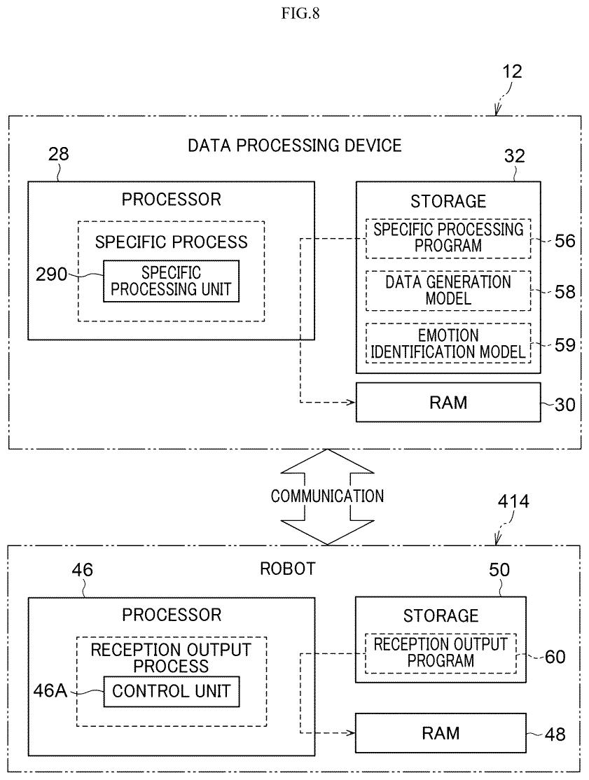

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

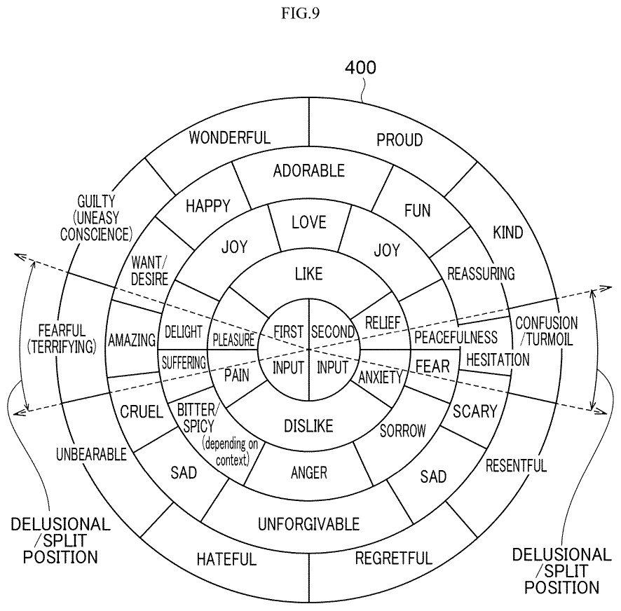

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

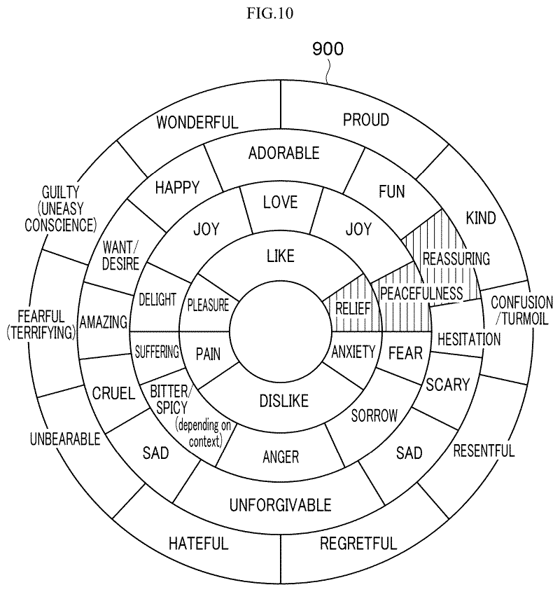

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
receive, from a terminal, personal attribute information and preference conditions of a user, and store the personal attribute information in a data storage device in a security environment,
perform preprocessing including normalization and feature extraction on the personal attribute information stored in the data storage device to generate input data for an information generation processing apparatus,
transmit, to a generative AI model as the information generation processing apparatus, an input text including the preprocessed personal attribute information and instructing the generative AI model to generate a prompt sentence that specifies search conditions for job information suitable for the user, and acquire the prompt sentence from the generative AI model,
generate a search query for a job information storage device storing job information, based on content of the acquired prompt sentence, acquire candidate job information from the job information storage device, and filter and rank the candidate job information based on the preference conditions of the user and a degree of skill matching,
transmit the filtered and ranked job information to the terminal and present the filtered and ranked job information as information for supporting job selection by the user,
record progress information of the user in the data storage device, adjust content of a relocation process and related procedures according to the progress information, and transmit, to the generative AI model, an input text for causing the generative AI model to generate a prompt sentence related to proposals for the relocation process, and
analyze behavior information or utterance information acquired from the terminal to recognize an emotional state of the user, and change the presented job information or proposed content of the relocation process based on an analysis result.

### (Supplementary 2)

The system according to supplementary 1,
wherein the processor is configured to perform information protection processing including encryption and access control when transmitting the personal attribute information and the progress information to the data storage device, thereby maintaining confidentiality and
integrity of the information in the security environment.

### (Supplementary 3)

The system according to supplementary 1,
wherein the processor is configured to re-filter or re-rank the candidate job information acquired from the job information storage device using the prompt sentence acquired from the generative AI model, based on the progress information and the emotional state of the user, and to automatically propose procedures necessary to comprehensively support the relocation process.

### Application Example 1

### (Supplementary 1)

A system comprising a processor,
wherein the processor is configured to
   display, on a communication terminal, an operation screen for inputting personal information, and receive the personal information including basic attributes, employment history, capability information, and job preference conditions from the communication terminal,
   acquire the personal information transmitted from the communication terminal via a communication line, and store the personal information in a dedicated data storage device in a security environment by using encrypted communication,
   acquire the personal information stored in the dedicated data storage device, perform preprocessing of the personal information by text normalization processing and attribute conversion processing, and automatically generate a prompt sentence for causing a generative AI model to generate a draft of a resume based on the preprocessed information,
   input the automatically generated prompt sentence and the preprocessed information to the generative AI model, cause the generative AI model to generate job candidate information including the draft of the resume, and acquire an output result from the generative AI model, analyze the job candidate information acquired from the generative AI model, calculate a degree of compatibility between the job candidate information and the personal information, rank the job candidate information based on the degree of compatibility, and present a ranked job recommendation result to the communication terminal,
   estimate an emotional state of a user based on operation information and biological information or behavior information input from the communication terminal, adjust content or timing of presentation of the job recommendation result in accordance with the emotional state, and control a progress procedure of a relocation process or a job selection process, and
   store procedure progress information of the user, generate a prompt sentence for causing the generative AI model to automatically propose necessary procedures based on the progress information and the job candidate information, and present proposal contents of the necessary procedures to the communication terminal.

### (Supplementary 2)

The system according to supplementary 1,
wherein the processor is configured to
   update, in a learning manner, a templated prompt sentence by using a plurality of pieces of personal information stored in the dedicated data storage device and job candidate information corresponding to the plurality of pieces of personal information, and dynamically change description items and an output format of the prompt sentence in accordance with contents of the personal information.

### (Supplementary 3)

The system according to supplementary 1,
wherein the processor is configured to
   transmit, to the generative AI model, an explanatory prompt sentence including a specific job candidate selected by the user and the personal information, cause the generative AI model to generate explanatory information that explains reasons why the specific job candidate is suitable for the user and capability deficiencies of the user, and display the explanatory information on the communication terminal.

### Example 2

### (Supplementary 1)

A system comprising a processor,
wherein the processor is configured to
   acquire personal history information from a terminal, generate structured information based on the personal history information, and store the structured information in a data storage apparatus in a secure environment,
   construct, based on the structured information, a prompt sentence in a natural language that instructs generation of a curriculum vitae, transmit the prompt sentence to a generative AI model including a language processing mechanism to cause the generative AI model to generate a draft of the curriculum vitae, and receive the draft of the curriculum vitae from the generative AI model,
   perform, on the draft of the curriculum vitae, chronological reordering of work history, classification of skill information, and formatting into a predetermined document structure, convert the formatted curriculum vitae into a display data format or a print data format, and provide the converted curriculum vitae to the terminal, and
   recognize an emotional state of a user and adjust a process relating to generation of the curriculum vitae and guidance of migration-related procedures in accordance with the emotional state.

### (Supplementary 2)

The system according to supplementary 1,
wherein the processor is configured to
   control a communication control mechanism in the terminal and in the system so as to encrypt, by using an encryption processing mechanism, the personal history information and the prompt sentence when transmitting the personal history information and the prompt sentence to the data storage apparatus in the secure environment or to the language processing mechanism included in the generative AI model, and to transmit the encrypted information through a secure communication path.

### (Supplementary 3)

The System According to Supplementary 1,
wherein the processor is configured to store progress information relating to migration procedures of the user in the data storage apparatus, generate, based on the progress information and information relating to the curriculum vitae, a prompt sentence including content for automatically proposing required administrative procedures or life-related procedures, and transmit the prompt sentence to the language processing mechanism included in the generative AI model to cause the generative AI model to generate guidance information for comprehensively supporting a migration process.

### Application Example 2

### (Supplementary 1)

A system comprising a processor,
wherein the processor is configured to
   receive, from a terminal, personal information and store the personal information in a protected storage area,
   construct, on the basis of the personal information, a prompt sentence for generating work-history information and proposal-document information, transmit the prompt sentence to a generative AI model, and acquire natural-language text representing the work-history information and the proposal-document information from the generative AI model, generate electronic document data based on the proposal-document information and transmit the electronic document data to an external device via an electronic payment service, perform emotion-analysis processing on text data or voice data acquired from a user to identify an emotional state of the user,
   dynamically adjust at least one of progression conditions, task-presentation contents, and schedules of a migration process or an employment-and-residence decision-making process, based on the emotional state and at least a part of one or more of the work-history information, the proposal-document information, and the electronic document data, and generate output data for presenting the work-history information, the proposal-document information, the electronic document data, and information relating to the adjusted process to the terminal.

### (Supplementary 2)

The system according to supplementary 1,
wherein the processor is configured to
   encrypt the personal information using a data-encryption technique when storing the personal information in the protected storage area, and transmit and receive the personal information via a secure communication channel.

### (Supplementary 3)

The system according to supplementary 1,
wherein the processor is configured to
extract, based on progress information of the user, the emotional state, and at least one of the work-history information and the proposal-document information obtained from the generative AI model, a plurality of tasks relating to at least one of migration procedures, employment activities, residence search, and electronic payment plan selection, generate a prompt sentence including management information indicating a priority or execution timing of the plurality of tasks, transmit the prompt sentence to the generative AI model to cause automatic generation of proposal contents or explanatory text for the tasks, and control the system to automatically propose required procedures to the user based on a result obtained from the generative AI model.

What is claimed is:

1. A system comprising:
circuitry configured to:
receive, via a communication interface coupled to a packet-switched network, attribute data and preference condition data of a user from a terminal device, and store the attribute data in a storage device within a security environment using encryption and access control processing;
perform preprocessing on the stored attribute data, the preprocessing comprising normalization and feature extraction, to generate input data for a generative model;
transmit, to the generative model via the communication interface, an input text comprising the input data and an instruction to generate a query construction prompt sentence specifying search conditions, and acquire the query construction prompt sentence from the generative model;
generate a search query from the query construction prompt sentence, execute the search query against a candidate data store to retrieve candidate records, and filter and rank the candidate records based on the preference condition data and a degree of attribute matching to produce a ranked candidate list;
transmit the ranked candidate list to the terminal device via the communication interface, record progress data of the user in the storage device, construct a process proposal input text based on the progress data, transmit the process proposal input text to the generative model, and acquire a process proposal from the generative model; and
receive behavior data or utterance data from the terminal device, analyze the behavior data or utterance data to recognize an emotional state of the user, and adjust the ranked candidate list or the process proposal based on the recognized emotional state.

2. The system according to claim 1, wherein the preprocessing further comprises tokenization and vocabulary normalization of text fields within the attribute data, and wherein the input data is formatted as a structured record comprising normalized numerical values and tokenized text sequences.

3. The system according to claim 2, wherein generating the search query from the query construction prompt sentence comprises parsing the query construction prompt sentence to extract at least one search condition token, mapping each search condition token to a corresponding index field in the candidate data store, and constructing a query expression comprising the mapped index fields and associated condition values.

4. The system according to claim 3, wherein filtering and ranking the candidate records comprises computing, for each candidate record, a matching score based on a weighted sum of attribute overlap values between the candidate record and the attribute data, and ordering the candidate records by descending matching score.

5. The system according to claim 4, wherein the matching score is computed using a cosine similarity between a vector representation of the candidate record and a vector representation of the input data, and wherein the vector representations are generated by an encoder model stored in the storage device.

6. The system according to claim 1, wherein the circuitry is configured to update the process proposal based on a transition between progress states recorded in the progress data, and to transmit an updated process proposal to the terminal device when the progress data indicates a transition to a new progress state.

7. The system according to claim 6, wherein the process proposal input text is constructed by inserting the progress data and a process state identifier into a proposal prompt template, and wherein the proposal prompt template is retrieved from the storage device based on the process state identifier.

8. The system according to claim 1, wherein recognizing the emotional state of the user comprises executing an emotion classification model on features extracted from the behavior data or utterance data, the emotion classification model outputting an emotion category label and a confidence score.

9. The system according to claim 8, wherein adjusting the ranked candidate list based on the recognized emotional state comprises applying a re-ranking transformation to the ranked candidate list that modifies position weights of candidate records based on a preference profile associated with the emotion category label stored in the storage device.

10. The system according to claim 1, wherein the circuitry is configured to receive document generation instructions from the terminal device, construct a document generation prompt sentence incorporating selected attribute data and a document type indicator, transmit the document generation prompt sentence to the generative model, and receive draft document text from the generative model in response to the document generation prompt sentence.

11. The system according to claim 10, wherein the document type indicator specifies one of a resume format, a cover letter format, and a summary statement format, and wherein the document generation prompt sentence includes a language code and a length constraint in addition to the selected attribute data and the document type indicator.

12. The system according to claim 1, wherein the information protection processing comprises applying a symmetric encryption algorithm to the attribute data before storing the attribute data in the storage device, storing an encryption key in a key management module separate from the storage device, and logging each access event to the storage device in an access control log.

13. The system according to claim 12, wherein the circuitry is configured to detect unauthorized access attempts based on the access control log by comparing access events against an access policy stored in the key management module, and to transmit an alert notification to an administrator terminal via the communication interface when an unauthorized access attempt is detected.

14. The system according to claim 1, wherein the candidate data store is an external database accessible via the communication interface, and wherein the search query is transmitted to the external database as a structured query message over the packet-switched network, and the candidate records are received as a response message from the external database.

15. The system according to claim 14, wherein the circuitry is configured to cache, in the storage device, a set of most recently retrieved candidate records together with a cache timestamp, and to serve the cached candidate records in response to a subsequent identical search query when an elapsed time since the cache timestamp is below a cache validity period.

16. The system according to claim 1, wherein the circuitry is configured to receive a feedback signal from the terminal device indicating a user's evaluation of a candidate record in the ranked candidate list, update a preference weight vector stored in the storage device based on the feedback signal, and apply the updated preference weight vector when generating a subsequent ranked candidate list.

17. The system according to claim 16, wherein updating the preference weight vector comprises computing a gradient of a ranking loss function based on the feedback signal and the attribute matching scores of the evaluated candidate record, and updating the preference weight vector by applying a gradient descent step scaled by a learning rate parameter.

18. A system comprising:
circuitry configured to:
receive, via a communication interface coupled to a packet-switched network, attribute data and preference condition data of a user from a terminal device, and store the attribute data in a storage device using encryption and access control processing;
perform preprocessing on the stored attribute data comprising normalization and feature extraction to generate input data, and transmit an input text comprising the input data to a generative model via the communication interface to acquire a query construction prompt sentence from the generative model;
generate a search query from the query construction prompt sentence, retrieve candidate records from a candidate data store, and filter and rank the candidate records based on the preference condition data and a degree of attribute matching; and
transmit a ranked candidate list to the terminal device via the communication interface, and adjust the ranked candidate list based on an emotional state of the user recognized from behavior data or utterance data received from the terminal device.

19. The system according to claim 18, wherein the circuitry is configured to record progress data of the user in the storage device, construct a process proposal input text based on the progress data, transmit the process proposal input text to the generative model, acquire a process proposal from the generative model, and transmit the process proposal to the terminal device.

20. A method comprising:
receiving, via a communication interface coupled to a packet-switched network, attribute data and preference condition data of a user from a terminal device, and storing the attribute data in a storage device within a security environment using encryption and access control processing;
performing preprocessing on the stored attribute data, the preprocessing comprising normalization and feature extraction, to generate input data for a generative model;
transmitting, to the generative model via the communication interface, an input text comprising the input data and an instruction to generate a query construction prompt sentence specifying search conditions, and acquiring the query construction prompt sentence from the generative model;
generating a search query from the query construction prompt sentence, executing the search query against a candidate data store to retrieve candidate records, and filtering and ranking the candidate records based on the preference condition data and a degree of attribute matching to produce a ranked candidate list;
transmitting the ranked candidate list to the terminal device via the communication interface, recording progress data of the user in the storage device, constructing a process proposal input text based on the progress data, transmitting the process proposal input text to the generative model, and acquiring a process proposal from the generative model; and
receiving behavior data or utterance data from the terminal device, analyzing the behavior data or utterance data to recognize an emotional state of the user, and adjusting the ranked candidate list or the process proposal based on the recognized emotional state.
